(19) United States
(12) Patent Application Publication
(10) Pub. No.: US 2011/0050723 A1
(43) Pub. Date: Mar. 3, 2011

(54) IMAGE PROCESSING APPARATUS AND METHOD, AND PROGRAM

(75) Inventors: Nodoka TOKUNAGA, Tokyo (JP); Jun Murayama, Tokyo (JP)

(73) Assignee: Sony Corporation, Tokyo (JP)

(21) Appl. No.: 12/845,284

(22) Filed: Jul. 28, 2010

(30) Foreign Application Priority Data
Sep. 3, 2009 (JP) 2009-204040
Feb. 10, 2010 (JP) 2010-027197
Feb. 10, 2010 (JP) 2010-027198
Feb. 10, 2010 (JP) 2010-027199

(51) Int. Cl. G09G 5/00

(52) U.S. Cl. 345/627

(57) ABSTRACT

An image processing apparatus includes: a dividing unit configured to divide an input image into blocks having a shape determined beforehand of a predetermined number of pixels; a suitability calculating unit configured to calculate, by matching a specified image specified beforehand, and the image of each of the divided blocks by standards determined beforehand, the suitability of the specified image for each of the blocks; an insertion block determining unit configured to determine a block into which the specified image should be inserted based on the calculated suitability; and a specified image inserting unit configured to insert the specified image by replacing the image of the determined block with the specified image.

### BACKGROUND OF THE INVENTION

1. Field of the Invention

The present invention relates to an image processing apparatus and method, and a program, and more specifically relates to an image processing apparatus and method, and a program, whereby a beautiful photomosaic image can be generated without any use of a special device, special skills, or the like.

2. Description of the Related Art

In recent years, many images can be readily taken due to widespread use of digital cameras. A photomosaic image is an image created by combining a great number of photos such as mosaics. Heretofore, for example, photomosaic images have often been created for commercial use such as posters for advertising movies, company logos, and so forth. With creation of a photomosaic image, advanced technology is demanded in that a great number of images are prepared, and an image to be used as a mosaic tile is suitably selected.

However, such as described above, along with the widespread use of digital cameras, and expansion of information technology, even a general user has come to be able to create photomosaic images.

For example, a technique has been proposed wherein an image of a database to be employed as each block of a produced target image is determined by calculating distance between the representing value of each block of the produced target image, and the representing value of each image of the database in a weighted manner (e.g., see Japanese Unexamined Patent Application Publication No. 2000-298722).

Also, a technique has been proposed wherein the representing value of each block of a produced target image is calculated, a region is separated using an approximate color, images of a database are subjected to clustering using the representing value of each image, and the images of the corresponding class are sequentially used as to the region separation results of each block of the produced target image (e.g., see Japanese Unexamined Patent Application Publication No. 2005-100120).

Further, a technique has also been proposed wherein a photomosaic image is generated while maintaining the color distribution of the original image by finely dividing each block of a produced target image, and matching these (e.g., see Japanese Unexamined Patent Application Publication No. 11-341266).

Also, a technique has been proposed wherein according to a result obtained by adding weight specified by a user to difference between a small region more finely divided from each block of a produced target image, and a small region more finely divided from an image of a database, and an image of the database to be employed as each tile is determined (e.g., see Japanese Unexamined Patent Application Publication No. 2000-295453).

Further, it has also been proposed to select an image of a database using a mean luminance value, and mean distance of L*a*b* (e.g., see Japanese Unexamined Patent Application Publication No. 11-341264).

Also, a technique has been proposed wherein the layout of an image of an image database is determined on a server by matching an image of the image database on the server, and a block of a produced target image through a network, and a photomosaic image is generated at the client side (e.g., see Japanese Unexamined Patent Application Publication No. 2000-200283).

### SUMMARY OF THE INVENTION

However, with the technique according to Japanese Unexamined Patent Application Publication No. 2000-298722, only the representing value is employed to determine an image of the image database to be employed, and accordingly, the texture of the produced target image may not be represented with the generated photomosaic image. Also, with the techniques according to Japanese Unexamined Patent Application Publication Nos. 2000-298722, 11-341266, 2000-295453, 11-341264, and 2000-200283, matching with all of the images of the image database has to be performed regarding each block of the produced target image, and accordingly, the amount of calculation is great, and the processing takes time.

Further, even when employing the technique according to Japanese Unexamined Patent Application Publication No. 2005-100120 or 2000-200283, there has been a problem wherein in the event that the images of the corresponding class have not sufficiently been prepared as to the region separation results of each block of the produced target image, many duplications occur, and the quality of the generated photomosaic image deteriorates.

Also, when taking realistic processing time into consideration, while it is difficult to increase the number of blocks of the produced target image too much, with the image generated as a photomosaic image, for example, the number of blocks to be disposed in a feature portion such as the eyes, mouth or the like of a human face has to be suitably adjusted. For example, even when attempting to represent such a feature portion with a single block, this causes the image to look strange for a human face.

Therefore, in the event of creating a photomosaic image, the size of the produced target image has to be suitably adjusted while taking the size of an image serving as a mosaic tile (the size of the block) into consideration, and such size adjustment demands a high skill.

Further, the related art has not been able to realize control regarding how much of which image is employed as a tile of the images of the image database. As a result thereof, for example, a photomosaic image where a user's desired images are almost not employed may be generated.

It goes without saying that when an image of the image database is selected beforehand, generation of a photomosaic image employing the user's desired images can be performed in a broad sense. However, even in this way, it is untellable which image has been employed in which portion of the photomosaic image, and if the image of a predetermined tile is forcibly determined, it is difficult to generate a beautiful photomosaic image.

Also, with the related art, an image unsuitable as a mosaic tile has not been prevented from being employed as a mosaic tile.

Further, there has been a problem in that, in the event that an image unsuitable as a produced target image has been input, even when suitably selecting an image to be pasted on each block, the quality of the generated photomosaic image deteriorates. With the related art, an image unsuitable as a produced target image has not been able to be determined.

It has been found to be desirable to enable a beautiful photomosaic image to be generated without any use of a special device, special skills, or the like.

An embodiment of the present invention is an image processing apparatus including: a dividing unit configured to divide an input image into blocks having a shape determined beforehand of a predetermined number of pixels; a suitability calculating unit configured to calculate, by matching a specified image specified beforehand, and the image of each of the divided blocks by standards determined beforehand, the suitability of the specified image for each of the blocks; an insertion block determining unit configured to determine a block into which the specified image should be inserted based on the calculated suitability; and a specified image inserting unit configured to insert the specified image by replacing the image of the determined block with the specified image.

The image processing apparatus may further include a region specifying unit configured to accept specification of a region into which the specified image should be inserted within the input image; with the suitability calculating unit calculating the suitability of the specified image by matching the specified image, and the image of a block corresponding to the region of which the specification has been accepted of the images of the divided blocks by standards determined beforehand.

The image processing apparatus may further include a weighting unit configured to subject the suitability calculated for each of the blocks to weighting using a weighting table to be set according to distance between the block and a block of which the position is set beforehand within the input image.

The specified image inserting unit may insert a plurality of the specified images into a plurality of the blocks, respectively; with the insertion block determining unit setting a flag representing that insertion has been done to the block into which a predetermined specified image should be inserted, and determining a block into which another specified image should be inserted out of blocks other than a block positioned within a predetermined range around of the block to which the flag has been set.

The image processing apparatus may further include a photomosaic image generating unit configured to classify, based on the representing value of the image of each block of the input image, each of the blocks into a plurality of classes set beforehand; classify a plurality of material images stored as an image to be pasted on the block into the plurality of classes; and determine a material image to be pasted on the block by matching each of material images classified into the same class as the class of the block, and the image of the block by standard determined beforehand.

The image processing apparatus may further include a selecting unit configured to select an image serving as a material image object to be pasted on the block, of a plurality of the material images.

The selecting unit may select an image serving as a material image object to be pasted on the block by excluding an image selected beforehand as an image which a user feels to be visually strange, from the material images.

The selecting unit may include a correcting unit configured to correct an image including noise, a blurred image, or an image to which a frame is appended; and a presenting unit configured to present an image corrected by the correcting unit to the user; with the selecting unit selecting an image serving as a material image object to be pasted on the block by excluding an image selected beforehand as an image which the user feels to be visually strange, from the material images.

An embodiment of the present invention is an image processing method including the steps of: dividing, with a dividing unit, an input image into blocks having a shape determined beforehand of a predetermined number of pixels; calculating, with a suitability calculating unit, by matching a specified image specified beforehand, and the image of each of the divided blocks by standards determined beforehand, the suitability of the specified image for each of the blocks; determining, with an insertion block determining unit, a block into which the specified image should be inserted based on the calculated suitability; and inserting, with a specified image inserting unit, the specified image by replacing the image of the determined block with the specified image.

An embodiment of the present invention is a program causing a computer to serve as an image processing apparatus including: a dividing unit configured to divide an input image into blocks having a shape determined beforehand of a predetermined number of pixels; a suitability calculating unit configured to calculate, by matching a specified image specified beforehand, and the image of each of the divided blocks by standards determined beforehand, the suitability of the specified image for each of the blocks; an insertion block determining unit configured to determine a block into which the specified image should be inserted based on the calculated suitability; and a specified image inserting unit configured to insert the specified image by replacing the image of the determined block with the specified image.

With the above configurations, an input image is divided into blocks having a shape determined beforehand of a predetermined number of pixels, the suitability of the specified image for each of the blocks is calculated by matching a specified image specified beforehand, and the image of each of the divided blocks by standards determined beforehand, a block into which the specified image should be inserted is determined based on the calculated suitability, and the specified image is inserted by replacing the image of the determined block with the specified image.

An embodiment of the present invention is an image processing apparatus including: a dividing unit configured to divide an input image into blocks having a shape determined beforehand of a predetermined number of pixels; a block image classifying unit configured to classify each of the blocks into a plurality of classes set beforehand based on the representing value of the image of each of the divided blocks; a material image classifying unit configured to classify a plurality of material images stored as an image to be pasted on the block into the plurality of classes based on the representing value of the image of each of the divided blocks; a candidate image output unit configured to calculate the suitability of the material images by matching each of the material images classified into the same class as the class of the block with the image of the block by standard determined beforehand to output a plurality of candidate images serving as a candidate of a material image to be pasted on each of the blocks along with the suitability; and a candidate image selecting unit configured to select a material image to be pasted on the block out of the candidate images so that the ratio of a block on which a predetermined type of image is pasted as to all of the blocks of the input image becomes a predetermined ratio.

With all of the blocks of the input image, in the event that of the plurality of candidate images, a first candidate image of which the suitability is the highest has been pasted as the material image, when the ratio of a block on which a predetermined type of image is pasted as to all of the blocks of the input image is not matched with a ratio set beforehand, the candidate image selecting unit may determine an object block that is a block on which a candidate image different from the first candidate image should be pasted of all of the blocks of the input image to replace an image to be selected as an image to be pasted on the object block with a second candidate image of which the suitability is the second highest.

The candidate image selecting unit may determine, after an image to be selected as an image to be pasted on the object block is replaced, with all of the blocks of the input image, whether or not the ratio of a block on which a predetermined type of image is pasted as to all of the blocks of the input image is matched with a ratio set beforehand, and in the event that determination is made that the ratio is not matched with the ratio set beforehand, determine the object block again, and replace the image of the determined object block again.

The candidate image selecting unit may determine the object block based on the suitability of the material image.

The candidate image selecting unit may eliminate, when replacing an image to be selected as an image to be pasted on the object block, the data of the material image selected before replacement.

The candidate image output unit may calculate, based on distance between a pixel value of a material image classified into the class of the block, and the pixel value of the corresponding pixel in the image of the block, the suitability of a material image to be pasted on the block.

The image processing apparatus may further include a center value calculating unit configured to calculate a center value of the plurality of classes based on the representing value of the image of each block of the input image; with the block image classifying unit classifying, based on distance between the center value and the representing value of the image of the block, the image of the block into the plurality of classes; and with the material image classifying unit classifying, based on the distance between the center value and the representing value of the material image, and a threshold of the distance, the material image into the plurality of classes.

An embodiment of the present invention is an image processing method including the steps of: dividing, with a dividing unit, an input image into blocks having a shape determined beforehand of a predetermined number of pixels; classifying, with a block image classifying unit, each of the blocks into a plurality of classes set beforehand based on the representing value of the image of each of the divided blocks; classifying, with a material image classifying unit, a plurality of material images stored as an image to be pasted on the block into the plurality of classes based on the representing value of the image of each of the divided blocks; calculating, with a candidate image output unit, the suitability of the material images by matching each of the material images classified into the same class as the class of the block with the image of the block by standard determined beforehand to output a plurality of candidate images serving as a candidate of a material image to be pasted on each of the blocks along with the suitability; and selecting, with a candidate image selecting unit, a material image to be pasted on the block out of the candidate images so that the ratio of a block on which a predetermined type of image is pasted as to all of the blocks of the input image becomes a predetermined ratio.

An embodiment of the present invention is a program causing a computer to serve as an image processing apparatus including: a dividing unit configured to divide an input image into blocks having a shape determined beforehand of a predetermined number of pixels; a block image classifying unit configured to classify each of the blocks into a plurality of classes set beforehand based on the representing value of the image of each of the divided blocks; a material image classifying unit configured to classify a plurality of material images stored as an image to be pasted on the block into the plurality of classes based on the representing value of the image of each of the divided blocks; a candidate image output unit configured to calculate the suitability of the material images by matching each of the material images classified into the same class as the class of the block with the image of the block by standard determined beforehand to output a plurality of candidate images serving as a candidate of a material image to be pasted on each of the blocks along with the suitability; and a candidate image selecting unit configured to select a material image to be pasted on the block out of the candidate images so that the ratio of a block on which a predetermined type of image is pasted as to all of the blocks of the input image becomes a predetermined ratio.

With the above configurations, an input image is divided into blocks having a shape determined beforehand of a predetermined number of pixels, each of the blocks is classified into a plurality of classes set beforehand based on the representing value of the image of each of the divided blocks, a plurality of material images stored as an image to be pasted on the block is classified into the plurality of classes based on the representing value of the image of each of the divided blocks, the suitability of the material images is calculated by matching each of the material images classified into the same class as the class of the block with the image of the block by standard determined beforehand to output a plurality of candidate images serving as a candidate of a material image to be pasted on each of the blocks along with the suitability, a material image to be pasted on the block is selected out of the candidate images so that the ratio of a block on which a predetermined type of image is pasted as to all of the blocks of the input image becomes a predetermined ratio.

An embodiment of the present invention is an image processing apparatus including: a feature region extracting unit configured to extract the image of a region including an object set beforehand by analyzing an input image, as a feature region; a region size detecting unit configured to detect a size made up of the number of pixels of the extracted feature region; a scale determining unit configured to determine, based on the detected size of the feature region, and a layout method of a block having a predetermined shape of a predetermined number of pixels, which is a layout method corresponding to the type of the extracted feature region, scale for enlarging or reducing the image of the feature region so that the block is disposed in the feature region in accordance with the layout method; an enlarging/reducing unit configured to enlarge or reduce the input image based on the determined scale; and a photomosaic image generating unit configured to generate a photomosaic image corresponding to the input image by dividing the enlarged or reduced input image into the blocks and pasting a material image on each of the blocks.

The image processing apparatus may further include a layout method storage unit configured to store a layout method corresponding to the type of the extracted feature region.

The enlarging/reducing unit may enlarge or reduce the size of the block based on the inverse number of the scale determined by the scale determining unit without enlarging/reducing the input image.

The photomosaic image generating unit may classify, based on the representing value of the image of each block of the input image, each of the blocks into a plurality of classes set beforehand; classify a plurality of the material images stored as an image to be pasted on the block into the plurality of classes; and determine a material image to be pasted on the block by matching each of material images classified into the same class as the class of the block, and the image of the block by standard determined beforehand.

The photomosaic image generating unit may include a center value calculating unit configured to calculate a center value of the plurality of classes based on the representing value of the image of each block of the enlarged or reduced input image; with the photomosaic image generating unit classifying, based on distance between the center value and the representing value of the image of the block, the image of the block into the plurality of classes; and with the photomosaic image generating unit classifying, based on the distance between the center value and the representing value of the material images, and a threshold of the distance, the material image into the plurality of classes.

The photomosaic image generating unit may change the threshold according to the number of the material images classified into each of the plurality of classes, and based on distance between the center value and the representing value of the material images, and the changed threshold, classify the material images into the plurality of classes again.

The photomosaic image generating unit may perform the matching by calculating, based on distance between a pixel value of a material image classified into the class of the block, and the pixel value of the corresponding pixel in the image of the block, the suitability of a material image to be pasted on the block.

The photomosaic image generating unit may set the material image determined to be pasted on the block to a flag representing that the material image has been used; and determine the material image to be pasted on the other blocks, which are the material image classified into the same class as the class of the block thereof, out of material images to which the flag is not set.

The photomosaic image generating unit may determine the material image to be pasted on a block positioned within a predetermined range around the block out of the material images other than the material image determined to be pasted on the block.

The photomosaic image generating unit may determine the material image to be pasted on a block adjacent to the block out of the material images of which the similarity with the material image determined to be pasted on the block is equal to or less than a threshold.

The photomosaic image generating unit may keep, in the event that the material image of which the suitability is equal to or greater than a threshold set beforehand does not exist, the image of this block alive without change in the input image.

The feature region extracting unit may extract the image of region specified by a user as a feature region.

The block to be disposed in the feature region may be a block made up of a smaller number of pixels than the number of pixels to be disposed in other regions.

The image processing apparatus may further include a suitability determining unit configured to determine, based on a pixel of the image of a subject detected from the input image, whether or not the input image is an image suitable for generation of the photomosaic image.

The suitability determining unit may determine, based on difference between the value of a pixel making up the image of the detected subject, the value of a pixel of an image other than a subject adjacent to the pixels of the image of the subject, whether or not the input image is an image suitable for generation of the photomosaic image.

In the event that determination is made that the input image is not an image suitable for generation of the photomosaic image, the suitability determining unit may select a plurality of pixel value candidates used for the input image becoming an image suitable for generation of the photomosaic image, which are pixel values of an image other than a subject corresponding to the pixel values of the image of the detected subject; determine, based on the representing value of a plurality of the material images stored beforehand, the pixel values of the image other than the subject out of the plurality of candidates; and convert the pixel values of the image other than the subject using the determined pixel values.

The suitability determining unit may determine, based on the number of pixels making up the image of the detected subject, and the number of pixels making up the whole of the input image, whether or not the input image is an image suitable for generation of the photomosaic image.

An embodiment of the present invention is an image processing method including the steps of: extracting, with a feature region extracting unit, the image of a region including an object set beforehand by analyzing an input image, as a feature region; detecting, with a region size detecting unit, a size made up of the number of pixels of the extracted feature region; determining, with a scale determining unit, based on the detected size of the feature region, and a layout method of a block having a predetermined shape of a predetermined number of pixels, which is a layout method corresponding to the type of the extracted feature region, scale for enlarging or reducing the image of the feature region so that the block is disposed in the feature region in accordance with the layout method; enlarging or reducing, with an enlarging/reducing unit, the input image based on the determined scale; and generating, with a photomosaic image generating unit, a photomosaic image corresponding to the input image by dividing the enlarged or reduced input image into the blocks and pasting a material image on each of the blocks.

An embodiment of the present invention is a program causing a computer to serve as an image processing apparatus including: a feature region extracting unit configured to extract the image of a region including an object set beforehand by analyzing an input image, as a feature region; a region size detecting unit configured to detect a size made up of the number of pixels of the extracted feature region; a scale determining unit configured to determine, based on the detected size of the feature region, and a layout method of a block having a predetermined shape of a predetermined number of pixels, which is a layout method corresponding to the type of the extracted feature region, scale for enlarging or reducing the image of the feature region so that the block is disposed in the feature region in accordance with the layout method; an enlarging/reducing unit configured to enlarge or reduce the input image based on the determined scale; and a photomosaic image generating unit configured to generate a photomosaic image corresponding to the input image by dividing the enlarged or reduced input image into the blocks and pasting a material image on each of the blocks.

With the above configurations, the image of a region including an object set beforehand is extracted by analyzing an input image, as a feature region, a size made up of the number of pixels of the extracted feature region is detected, and based on the detected size of the feature region, and a layout method of a block having a predetermined shape of a predetermined number of pixels, which is a layout method corresponding to the type of the extracted feature region, scale for enlarging or reducing the image of the feature region is determined so that the block is disposed in the feature region in accordance with the layout method, the input image is enlarged or reduced based on the determined scale, and a photomosaic image corresponding to the input image is generated by dividing the enlarged or reduced input image into the blocks and pasting a material image on each of the blocks.

According to the above-described configurations, a beautiful photomosaic image can be generated without any use of a special device, special skills, or the like.

### BRIEF DESCRIPTION OF THE DRAWINGS

FIG. 1 is a block diagram illustrating a configuration example of a photomosaic image generating device according to an embodiment of the present invention;

FIG. 2 is a block diagram illustrating a detailed configuration example of the produced target image processing unit in FIG. 1;

FIG. 3 is a diagram illustrating an example of an input produced target image;

FIG. 4 is a block diagram illustrating a detailed configuration example of the photomosaic image generating unit in FIG. 1;

FIG. 5 is a diagram for describing constraint in the vicinity of N;

FIG. 6 is a flowchart for describing an example of photomosaic image generating processing;

FIG. 7 is a flowchart for describing an example of preparation processing for image generation;

FIG. 8 is a flowchart for describing image generating processing;

FIG. 9 is a diagram illustrating an example of a produced target image;

FIG. 10 is an example of an image where each block of the produced target image is filled with a pixel having the representing value of each block;

FIG. 11 is a flowchart for describing class classifying processing;

FIG. 12 is an image illustrating an example where each of the blocks shown in FIG. 10 is classified into a class;

FIG. 13 is a flowchart for describing an example of replaced image determining processing;

FIG. 14 is a diagram illustrating an example of a photomosaic image;

FIG. 15 is a diagram illustrating another example in the event that a produced target image is divided into blocks;

FIG. 16 is a block diagram illustrating a detailed configuration example of the photomosaic image generating unit in FIG. 1;

FIG. 17 is a block diagram illustrating a detailed configuration example of the tag processing unit in FIG. 16;

FIG. 18 is a flowchart for describing an example of image generating processing corresponding to the configuration in FIG. 16;

FIG. 19 is a flowchart for describing an example of image replacement processing;

FIG. 20 is a block diagram illustrating another configuration example of a photomosaic image generating device according to an embodiment of the present invention;

FIG. 21 is a block diagram illustrating a detailed configuration example of the specified image inserting unit in FIG. 20;

FIG. 22 is a flowchart for describing an example of photomosaic image generating processing corresponding to the configuration in FIG. 20;

FIG. 23 is a flowchart for describing an example of specified image inserting processing;

FIG. 24 is a block diagram illustrating another detailed configuration example of the specified image inserting unit in FIG. 20;

FIG. 25 is a flowchart for describing an example of specified image inserting processing corresponding to the configuration in FIG. 24;

FIG. 26 is a diagram illustrating an example of a photomosaic image before a specified image is inserted;

FIG. 27 is a diagram illustrating an example of a photomosaic image after a specified image is inserted;

FIG. 28 is a diagram illustrating an example of an image to which a frame is added;

FIG. 29 is a diagram illustrating an example of a photomosaic image generated using an unsuitable image serving as a mosaic tile;

FIG. 30 is a block diagram illustrating yet another configuration example of a photomosaic image generating device according to an embodiment of the present invention;

FIG. 31 is a block diagram illustrating a detailed configuration example of the image selecting unit in FIG. 30;

FIG. 32 is a flowchart for describing an example of photomosaic image generating processing corresponding to the configuration in FIG. 30;

FIG. 33 is a flowchart for describing an example of image selecting processing;

FIG. 34 is a diagram illustrating an example of an image where difference between the pixel values of a subject and the pixel values of the background is small;

FIG. 35 is a diagram illustrating an example of a photomosaic image generated with the image in FIG. 34 as a produced target image;

FIG. 36 is a diagram illustrating an example of an image where the size of a subject is extremely small;

FIG. 37 is a block diagram illustrating another configuration example of the photomosaic image generating device;

FIG. 38 is a block diagram illustrating a detailed configuration example of the produced target image determining unit in FIG. 37;

FIG. 39 is a flowchart for describing an example of produced target image determining processing by the produced target image determining unit in FIG. 38;

FIG. 40 is a block diagram illustrating another detailed configuration example of the produced target image determining unit in FIG. 37;

FIG. 41 is a flowchart for describing an example of produced target image determining processing by the produced target image determining unit in FIG. 40;

FIG. 42 is a block diagram illustrating yet another detailed configuration example of the produced target image determining unit in FIG. 37;

FIG. 43 is a flowchart for describing an example of produced target image determining processing by the produced target image determining unit in FIG. 42;

FIG. 44 is a flowchart for describing an example of background color conversion processing; and

FIG. 45 is a block diagram illustrating a configuration example of a personal computer.

### DESCRIPTION OF THE PREFERRED EMBODIMENTS

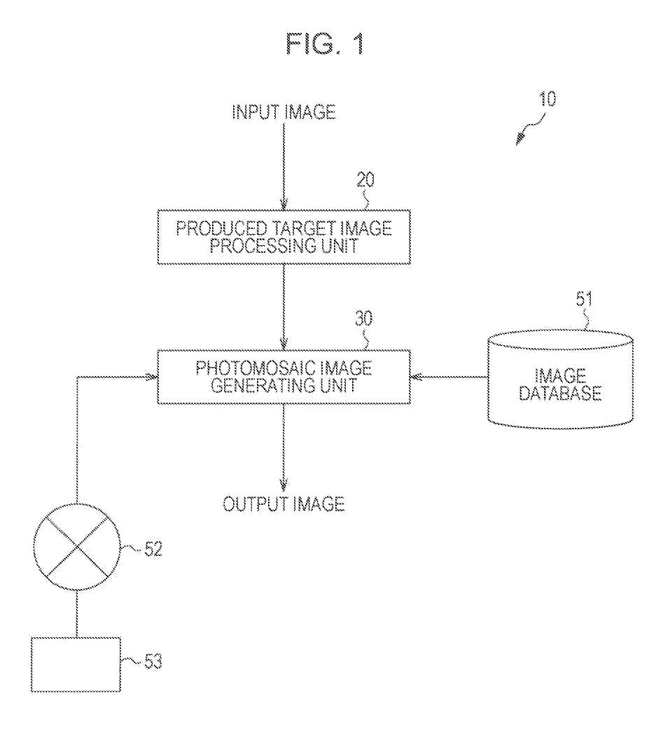

Now, an embodiment of the present invention will be described with reference to the drawings. FIG. 1 is a block diagram illustrating a configuration example of a photomosaic image generating device according to an embodiment of the present invention.

A photomosaic image is created by combining small images such as a great number of photos like mosaics as a single large image, for example. While a photomosaic image looks like a single photo in the event of being observed from a distance, the photomosaic image is generated so as to view an individual image serving as a mosaic tile one image at a time in the event of being observed up close.

Such as illustrated in the drawing, a photomosaic image generating device 10 is configured of a produced target image processing unit 20, and a photomosaic image generating unit 30.

The produced target image processing unit 20 is configured so as to accept a produced target image that is an image serving as the origin of an image to be generated as a photomosaic image. An example of the produced target image is a person's image. The produced target image processing unit 20 extracts a feature region from an input produced target image such as described later, for example. In the event that the produced target image is a person's image, examples of the feature region includes portions such as the eyes, nose, and mouth of the person's face.

The produced target image processing unit 20 determines the number of blocks to be allocated to the extracted feature region, and enlarges or reduces the feature region image so as to become an image corresponding to the number of blocks thereof. Subsequently, the produced target image processing unit 20 enlarges or reduces the whole of the produced target image in conformity to the scale of enlargement or reduction thereof.

The produced target image processing unit 20 supplies the produced target image thus enlarged or reduced to the photomosaic image generating unit 30. The photomosaic image generating unit 30 divides the whole of the produced target image obtained as the processing results of the produced target image processing unit 20 into blocks. The blocks have, for example, the same sized rectangular shape, and an image serving as a mosaic tile is arranged to be pasted on each of the blocks. Subsequently, the photomosaic image generating unit 30 selects an image suitable for each of these blocks and pastes this on the block thereof.

The photomosaic image generating unit 30 selects an image suitable for each block of the produced target image, for example, out of the images accumulated in an image database 51. Alternatively, the photomosaic image generating unit 30 selects an image suitable for each block of the produced target image, for example, out of the images accumulated in a server 53 connected to a network 52.

That is to say, the images accumulated in the image database 51, and the images accumulated in the server 53 are images to be used as a mosaic tile, i.e., images serving as a material of a photomosaic image.

The photomosaic image generating unit 30 performs class classification based on the pixel values of each block of the produced target image, and so forth, as described later. Thus, each block of the produced target image is classified into five classes, for example. Also, the photomosaic image generating unit 30 classifies, for example, the images accumulated in the image database 51 into five classes, for example, by the same method.

Subsequently, the photomosaic image generating unit 30 selects a single image out of the images accumulated in the image database 51 by performing matching between the image of each block of the produced target image, and the images of the image database 51 classified into the class of the block thereof.

The photomosaic image generating unit 30 pastes the image selected such as the above on each block of the produced target image as a mosaic tile. Thus, a photomosaic image is output as an output image.

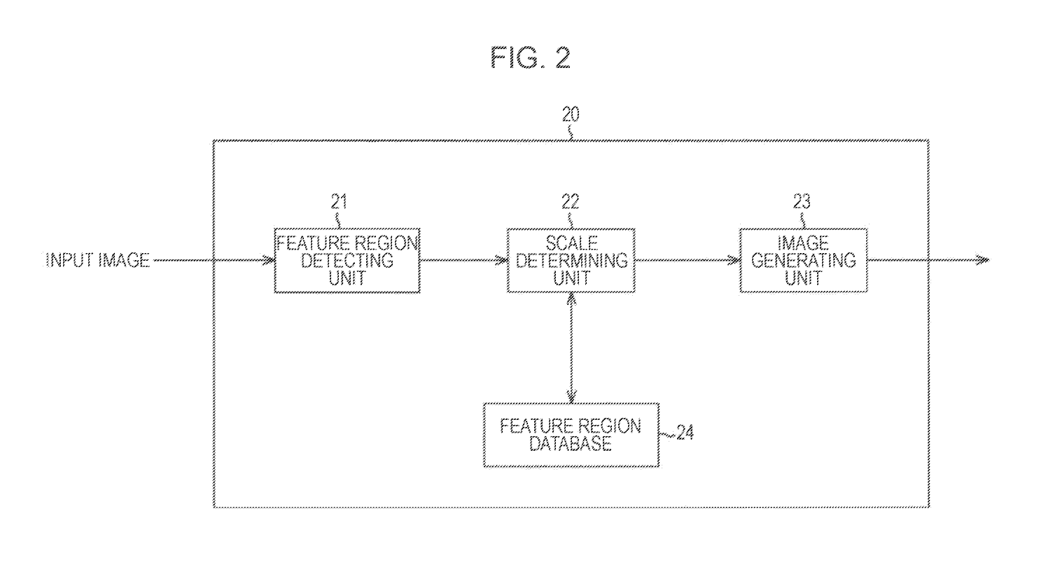

FIG. 2 is a block diagram illustrating a detailed configuration example of the produced target image processing unit 20 in FIG. 1. A feature region detecting unit 21 is configured to analyze the input produced target image to extract a feature region. For example, in the event that the produced target image is a person's image, the feature region detecting unit 21 detects a person's face by executing face image recognition processing or the like, and also determines a region making up the eye, mouth, or the like that is a feature portion within the face. Subsequently, information for determining a feature region such as the eye, mouth, or the like, and information such as the coordinate position and area of the determined region are obtained as the information of the extracted feature region.

The feature region detecting unit 21 extracts from the image, for example, flesh-colored pixels, and extracts a face image made up of the extracted flesh-colored pixels. Subsequently, the feature region detecting unit 21 determines a horizontal frame based on the number of continuous flesh-colored pixels included in the pixels in one column in the horizontal direction of the face image, obtains the height of a vertical frame by multiplying the width of the horizontal frame by a predetermined coefficient, and determines a position offset by predetermined length as to a vertical reference point to be the center of the vertical frame. The feature region detecting unit 21 extracts, for example, a face region within the frame of a square based on the horizontal frame and vertical frame thus obtained.

Subsequently, the feature region detecting unit 21 determines, for example, based on a value indicating the degree of matching between the image of the face region and a standard face image template, and the like, whether or not the image determined to be the face region is the real face image, and in the event that the face region is determined to be the face image, detects the eye or mouth or the like.

The feature region detecting unit 21 subjects, for example, non-flesh-colored pixels unequivalent to flesh-colored pixels to labeling of the pixels of the face region, and extracts objects. Subsequently, the feature region detecting unit 21 calculates the center of gravity of each of the objects made up of non-flesh-colored pixels of the face region, based on the labels, and detects an eye object, a mouth object, or the like based on center of gravity data indicating the center of gravity of each of the objects.

Further, the feature region detecting unit 21 sets a square region of a predetermined size based on data for determining the position of the detected object (e.g., data indicating the position of the center of gravity of the eye object), and determines the image of the square region thereof to be a feature region.

Note that the above method for extracting a feature region is an example, extraction of a feature region may be performed by other methods.

The feature region detecting unit 21 supplies the information of the feature region extracted such as described above to the scale determining unit 22.

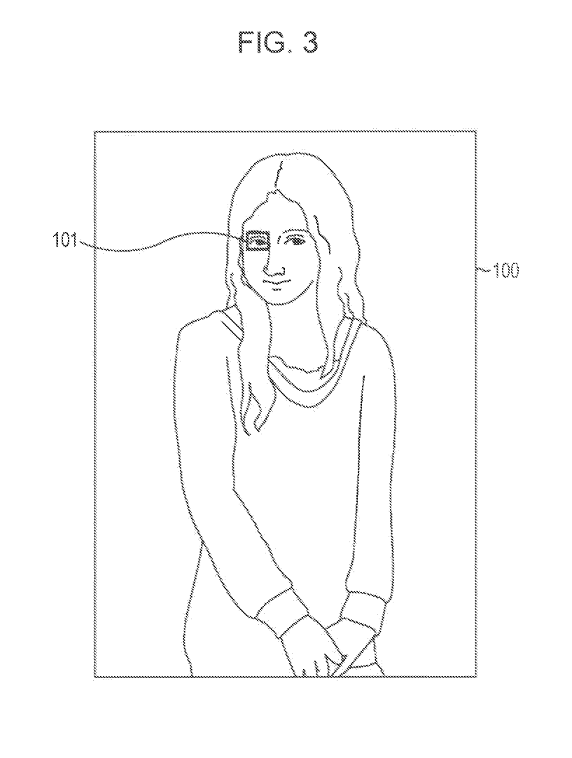

FIG. 3 is a diagram illustrating an example of an input produced target image. With this example, a produced target image 100 is determined to be a person's image. The feature region detecting unit 21 extracts an eye region indicated with a frame 101 in FIG. 3 as a feature region, for example.

The scale determining unit 22 detects the size of the extracted feature region. Here, the size is determined to be the number of pixels in the vertical direction and horizontal direction of the extracted feature region, for example.

A layout method of the block corresponding to a feature region is stored in a feature region database 24. For example, information of “horizontally 320×4, vertically 240×2” corresponding to the feature region of the eye is stored in the feature region database 24. This represents that the number of rectangular blocks made up of horizontally 320 pixels and horizontally 240 pixels to be disposed in the feature region of the eye is four in the horizontal direction, and two in the vertical direction. That is to say, a total of eight (i.e., 4×2) blocks of 76,800 (i.e., 320×240) pixels are disposed in the feature region of the eye.

Note that, for example, the layout method of the block corresponding to a feature region may be changed according to the resolution or size (paper size, aspect ratio, etc.) of a printer or display or the like, the orientation (landscape or portrait) of an image, or the like.

Similarly, for example, a layout method made up of the number of blocks in the horizontal direction, and the number of blocks in the vertical direction to be disposed in a mouth region is stored in the feature region database 24. That is to say, a layout method of the block corresponding to the type of a feature region, e.g., such as the eye, mouth, . . . , or the like is each disposed in the feature region database 24.

Now, let us say that the number of pixels of a block (320×240 in this case) is determined based on the size of an image stored in the image database 51, for example.

The scale determining unit 22 reads out, based on information for determining the eye, mouth, or the like the feature region thereof, a layout method of the block corresponding to the feature region thereof. Subsequently, the scale determining unit 22 calculates, based on the size of the feature region thus detected, and the layout method of the block read out from the feature region database 24, the enlargement or reduction ratio of the feature region.

For example, in the event that the eye has been extracted as a feature region, let us say that the size of the feature region extracted from the produced target image is represented with the number of pixels in the horizontal direction IM_XEYE, and the number of pixels in the vertical direction IM_YEYE. Also, let us say that the number of pixels in the horizontal direction to be obtained based on the layout method of the block read out from the feature region database 24 is represented with the number of pixels in the horizontal direction DB_XEYE, and the number of pixels in the vertical direction DB_YEYE.

In this case, the scale determining unit 22 obtains a change ratio Va in the vertical direction and a change ratio Ha in the horizontal direction by Expressions (1) and (2), and calculates the enlargement or reduction ratio of the feature region.

Va=DB_{—}YEYE/IM_{—}YEYE (1)

Ha=DB_{—}XEYE/IM_{—}XEYE (2)

The scale determining unit 22 determines, based on the enlargement or reduction ratio of the feature region thus obtained, the enlargement or reduction ratio of the whole of the produced target image. The enlargement or reduction ratio of the whole of the produced target image may be the same as the enlargement or reduction ratio of the feature region. Also, the above change ratio Va and change ratio Ha may be round off, round out, or truncated. Further, in the event that the change ratio Va and the change ratio Ha differ, for example, the change ratio in the vertical direction, and the change ratio in the horizontal direction may be processed so as to become the same value by selecting one of the ratios, or calculating a mean value thereof, or the like.

The scale determining unit 22 supplies the enlargement or reduction ratio of the whole of the produced target image to an image generating unit 23.

The image generating unit 23 enlarges or reduces the produced target image that is the input image by the enlargement or reduction ratio supplied from the scale determining unit 22.

Note that in the event that multiple feature regions (e.g., in the event that both eyes have each been extracted) have been extracted by the feature region detecting unit 21, the scale determining unit 22 detects each of the sizes thereof. Subsequently, for example, the enlargement or reduction ratio is calculated by calculating a mean value, or selecting any one of the feature regions in accordance with standard set beforehand, or the like.

With the above example, description has been made on the premise that the feature region detecting unit 21 analyzes the input produced target image to automatically extract a feature region, but for example, a region specified by a user using a mouse or the like may be extracted as a feature region.

In this case, for example, the user who specified a feature region further inputs information for determining the feature region thereof (e.g., eye, nose, mouth, etc.). Alternatively, an arrangement may be made wherein a feature region candidate list is presented to the user, and the feature region selected based on the candidate list is specified by the user.

When taking realistic processing time into consideration, while it is difficult to increase the number of blocks of the produced target image too much, with the image generated as a photomosaic image, for example, the number of blocks to be disposed in a feature portion such as the eyes, mouth or the like of a human face has to be suitably adjusted. For example, even when attempting to represent such a feature portion with a single block, this causes the image look strange for a human face.

Therefore, in the event of creating a photomosaic image, the size of the produced target image has to be suitably adjusted while taking the size of an image serving as a mosaic tile (the size of the block) into consideration, and such size adjustment demands a high skill.

On the other hand, with an embodiment of the present invention, the produced target image may automatically be reduced or enlarged based on the feature region of the produced target image, and the size of the block. Accordingly, a beautiful photomosaic image can be generated without special skills.

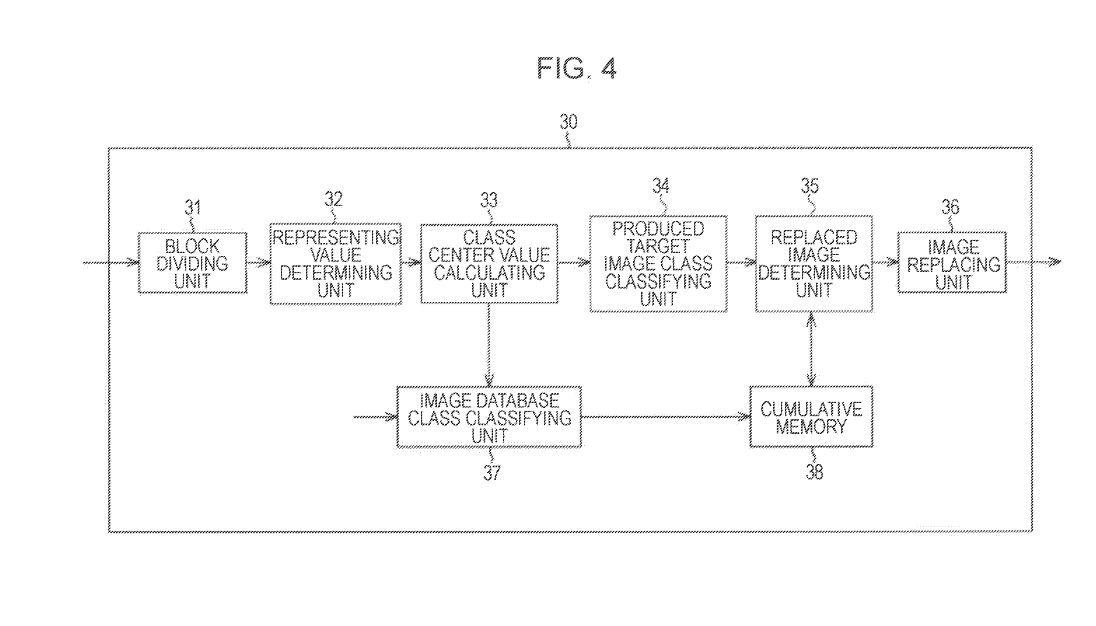

FIG. 4 is a block diagram illustrating a detailed configuration example of the photomosaic image generating unit 30 in FIG. 1.

Such as illustrated in this drawing, the photomosaic image generating unit 30 is configured so as to include a block dividing unit 31, a representing value determining unit 32, a class center value calculating unit 33, and a produced target image class classifying unit 34. Also, the photomosaic image generating unit 30 is configured so as to further include a replaced image determining unit 35, an image replacing unit 36, an image database class classifying unit 37, and cumulative memory 38.

The block dividing unit 31 divides the produced target image thus enlarged or reduced by the produced target image processing unit 20 into blocks. As described above, the blocks have, for example, the same sized rectangular shape, and an image serving as a mosaic tile is pasted on each of the blocks. The block dividing unit 31 divides the produced target image into rectangular blocks made up of horizontally 320 pixels and vertically 240 pixels, for example.

The representing value 32 determines the representing value of each block divided by the block diving unit 31. Here, for example, the representing value may be a mean value of the pixel value of the block thereof, or may be the pixel value at the coordinate position of the center of the block thereof. Alternatively, the mean value of the pixel value of the coordinate position determined beforehand within the block thereof may be the representing value.

The class center value calculating unit 33 calculates the center value of each class used for class classification by the clustering method, for example, such as the K-means method. With the later-described produced target image class classifying unit 34 and image database class classifying unit 37, class classification based on the center value calculated by the class center value calculating unit 33 is performed.

In the event that classification of five classes is performed at the produced target image class classifying unit 34 and image database class classifying unit 37, the class center value calculating unit 33 temporarily sets the representing values of five blocks of the edge portion of the produced target image as the center values of the five classes, respectively. Subsequently, the class center value calculating unit 33 classifies each block into five classes by comparing the center value and representing value of each class.

The class center value calculating unit 33 calculates the sum of squares of absolute values of difference of each of the RGB components of the pixel value corresponding to the center value thus temporarily set, and the pixel value corresponding to the representing value of each block to obtain distance between the center value of each class and the representing value of the block thereof. Subsequently, the class center value calculating unit 33 classifies the block thereof into a class having the shortest distance.

Thus, after a predetermined number of blocks are classified, the class center value calculating unit 33 temporarily sets the center value of each class again, for example, by calculating the mean value of the representing values of all of the blocks of each class, or the like. Subsequently, the class center value calculating unit 33 obtains distance between the center value of each class, and the representing value of each block to perform classification of the block thereof again.

The class center value calculating unit 33 executes block classification processing until the number of times of execution reaches a predetermined number of times, for example. Subsequently, the class center value calculating unit 33 supplies a value obtained by calculating the mean value of the representing values of all of the blocks of each class, or the like to the produced target image class classifying unit 34 and the image database class classifying unit 37 as the final center value of each of the classes.

The center values are calculated as the value of each of RGB components for each class, for example. For example, in the event of being classified into class 1, class 2, class 3, and so on, the center value of the class 1 is calculated as (235.9444, 147.9211, 71.6848), the center value of the class 2 is calculated as (177.6508, 115.0474, 61.7452), the center value of the class 3 is calculated as (76.7123, 63.5517, 42.3792), and so on. Three factors of the above center values represent the values of the R component, G component, and B component, respectively.

Note that the above center value calculating method is an example, and the center value of each class may be obtained by other methods.

The produced target image class classifying unit 34 classifies, based on the center value of each class supplied from the class center value calculating unit 33, the image of each block divided by the block dividing unit 31 into a class. Classification by the produced target image class classifying unit 34 is performed, for example, in the same way as with the above case, by obtaining distance between the center value of each class, and the representing value of each block.

The image database class classifying unit 37 classifies, based on the center value of each class supplied from the class center value calculating unit 33, the images of the image database 51 into a class, for example.

Classification by the image database class classifying unit 37 is performed, for example, in the same way as with the above case, by obtaining distance between the center value of each class, and the representing value of each image of the database. However, with classification by the image database class classifying unit 37, in the event that distance between the center value of the closest class, and the representing value of each image of the database exceeds a threshold, the image thereof is not classified into any class.

The threshold used for classification by the image database class classifying unit 37 is changed according to the number of classified images, for example. Thus, in the event that the number of images classified into a predetermined class is excessively small, or the like, the number of the images classified into the class thereof can be increased by increasing the threshold.

Thus, for example, an arrangement may be made wherein the image database class classifying unit 37 checks the number of images classified once for each class, and in the event that the number of images classified into a predetermined class is less than a reference value, changes the threshold to perform class classification again. Note that, as a result of changing the threshold in this way, the same image may be classed so as to belong to multiple classes.

The images classified into a class by the image database class classifying unit 37 are stored in the cumulative memory 38 in a manner correlated with the corresponding classified class.

Note that an arrangement may be made wherein the images stored in the image database 51 are further subjected to filter processing for removing shaking or blurring, and are stored in the cumulative memory 38 in a manner correlated with the corresponding classified class. Thus, the finished photomosaic image is changeable into a still more beautiful image.

The replaced image determining unit 35 performs processing for matching the image of a block classed into a class by the produced target image class classifying unit 34, with an image group of the class of the block thereof which are images stored in the cumulative memory 38 by calculation using the following Expression for example.

With processing for matching the images, for example, calculation of Expression (3) is first performed to obtain Δc.

$$Δ c = \sqrt{( 2 + \frac{\overline{r}}{256} ) * Δ {R}^{2} + {4}^{*} Δ {G}^{2} + ( 2 + \frac{255 - \overline{r}}{256} ) * Δ {B}^{2}} \\ \overline{r} = \frac{{C}_{1 R} + {C}_{2 R}}{2} \qquad ( 3 )$$

Here, ΔR, ΔG, and ΔB each represent difference between the values of the RGB components of the pixel values of a predetermined pixel of the image of a block, and the corresponding pixel of an image stored in the cumulative memory 38. Also, C_{1R} and C_{2R} each represent the value of the R component of a predetermined pixel of a block, and the value of the R component of the pixel value of the corresponding pixel in an image stored in the cumulative memory 38.

Note that the calculation of Δc by Expression (3) is performed regarding all of the pixels making up the image of a block, for example. For example, Δc is calculated regarding each of pixels represented with a coordinate position xy within a block.

Subsequently, with the processing for matching images, C is obtained by calculation in Expression (4) being performed. That is to say, Δc calculated by Expression (3) is totaled for all of the pixels worth within the block.

$$C = {\sum }_{x} {\sum }_{y} Δ {C}_{xy} \qquad ( 4 )$$

The value of C calculated by Expression (4) is stored in a manner correlated with an image stored in the cumulative memory 38, and the replaced image determining unit 35 compares the size of the value of C regarding each of the images stored in the cumulative memory 38. That is to say, the value of C is a value representing how much the image thereof is suitable (suitability) as an image to be pasted on this block, wherein we can say that the smaller the value of C is, the more the image thereof is a suitable image.

Note that calculations of Expressions (3) and (4) may be performed after thinning the pixels of the block of the produced target image, and the pixels of the image database. Thus, for example, the amount of calculation can be reduced, and the processing time can also be reduced.

Also, the above processing for matching images is an example, and matching of images may be performed by other methods. What matters is of the images of the image database classified into a class using the representing values, an image suitable for expressing the texture of each block of the produced target image should be determined to be an image to be pasted (replaced) on this block.

The replaced image determining unit 35 determines, for example, an image where the value of the above C is the smallest to be an image to be pasted (replaced) on this block. The replaced image determining unit 35 supplies the image thus determined to the image replacing unit 36.

The image replacing unit 36 replaces the image of this block with the image supplied from the replaced image determining unit 35. Thus, the images of all of the blocks are replaced with the image supplied from the replaced image determining unit 35, thereby generating a mosaic image.

Note that the replaced image determining unit 35 sets an image stored in the cumulative memory 38 to, for example, a predetermined flag, thereby determining a replaced image so that the same image is not redundantly used. For example, of the images stored in the cumulative memory 38, an image of which the flag has not been set is determined to be a replaced image until the flag is set to all of the images classified into the same class. In the event that the flag is set to all of the images classified into the same class, the flags of the images of this class are all cleared.

Alternatively, a constraint may be provided wherein the replaced image determining unit 35 does not use images of which the flag has been set only in the vicinity of N instead of using no images of which the flag has been set at all. Here, in the vicinity of N means N blocks adjacent to one block. For example, 8, 24, or the like is assumed as the value of N.

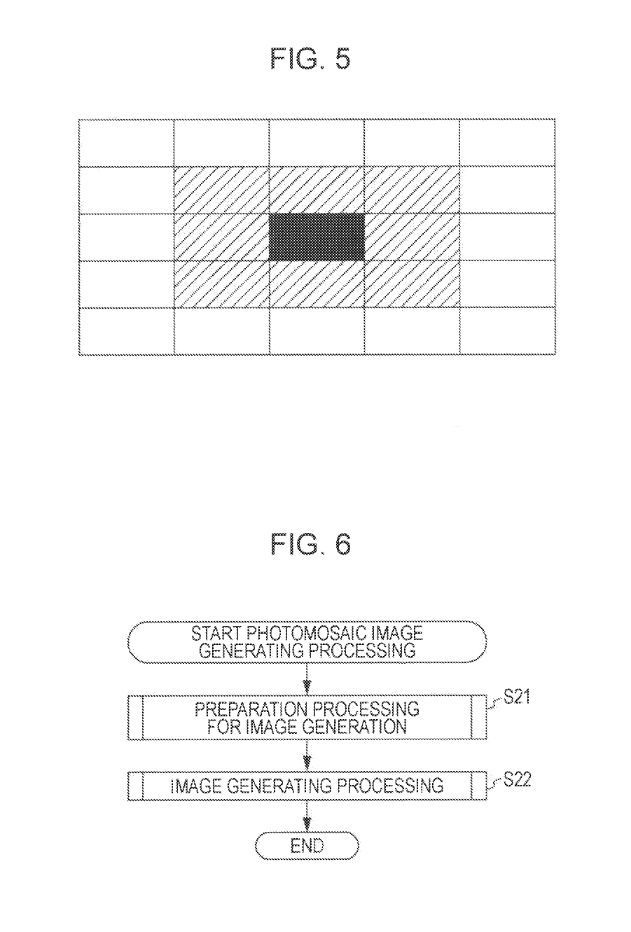

For example, in the event that the value of N is 8, the constraint in the vicinity of N is for example such as illustrated in FIG. 5. In FIG. 5, each rectangle represents each block of the produced target image. For example, such as illustrated in FIG. 5, an image used for a block indicated with a black rectangle at the center of the drawing is not prevented from being used in eight blocks indicated with hatching in the drawing. That is to say, in the event that there is the constraint in the vicinity of N, the replaced image determining unit 35 determines an image to be pasted on eight blocks indicated with hatching in the drawing out of images other than an image used for a block indicated with a black rectangle.

Thus, for example, a beautiful mosaic image can be generated even when the number of images that can be used as mosaic tiles is restricted.

Heretofore, for example, representing values alone have been used for determining an image of the image database to be pasted on a block, and accordingly, the texture of a produced target image has not often been able to be expressed in a generated photomosaic image. Also, in the event of matching the image of a block with an image of the image database so as to express the texture of the produced target image, matching with all of the images of the image database has to be performed regarding each block of the produced target image, and accordingly, the amount of calculation increases, and the processing takes time.

On the other hand, with an embodiment of the present invention, each block of the produced target image is classified into a class, an image of the image database is classified into a class using the same center value, and only images of the same class is matched. Thus, with an embodiment of the present invention, the texture of the produced target image can be expressed in the generated photomosaic image, and also the amount of calculation and the processing time can be reduced.

Also, heretofore, for example, in the event that the images of the image database have not sufficiently been prepared, there is a problem wherein a great number of duplications occur, and the quality of the generated photomosaic image deteriorates.

For example, a photomosaic image where a great number of the same images are employed as a mosaic tile is felt as an image having an unnatural pattern when being observed from a distance. In particular, in the event of generating the image of a person's face using a photomosaic image, or the like, we would have to say that a photomosaic image that gives an unnatural impression is low in quality.

On the other hand, with an embodiment of the present invention, a threshold to be used for classification by the image database class classifying unit 37 is changed according to the number of classified images, for example. Also, with an embodiment of the present invention, the replaced image determining unit 35 sets a flag, thereby determining a replaced image so that the same image is not redundantly used, or adding the constraint in the vicinity of N.

Thus, with an embodiment of the present invention, for example, in the event that the number of images classified into a predetermined class is small, or the like, the number of images to be classified into the class thereof can be increased by increasing the threshold. Also, with an embodiment of the present invention, even in the event that the number of images classified into a predetermined class is small, the same image can be prevented from being redundantly used as much as possible by the flags, and the constraint in the vicinity of N.

Next, the photomosaic image generating processing by the photomosaic image generating device 10 in FIG. 1 will be described with reference to the flowchart in FIG. 6.

In step S21, the produced target image processing unit 20 executes preparation processing for image generation. Thus, the produced target image is enlarged or reduced to a suitable size.

In step S22, the photomosaic image generating unit 30 executes image generating processing. Thus, a photomosaic image corresponding to the produced target image is generated.

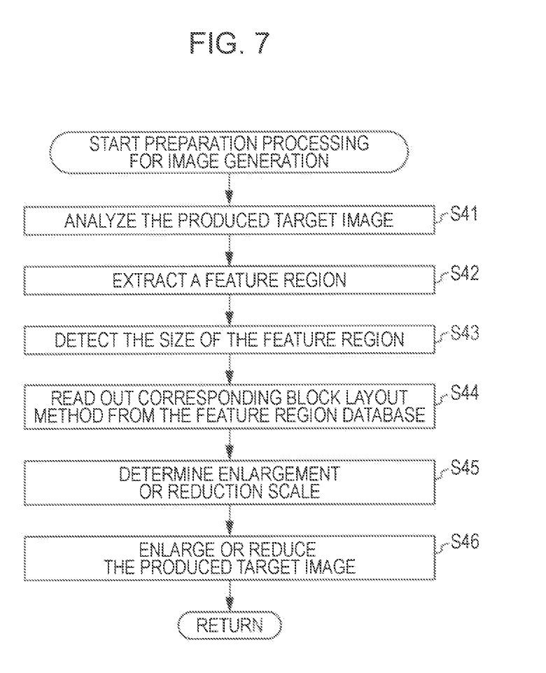

Next, a detailed example of the preparation processing for image generation to be executed in step S21 in FIG. 6 will be described with reference to the flowchart in FIG. 7.

In step S41, the feature region detecting unit 21 of the produced target image processing unit 20 analyzes the input produced target image.

At this time, for example, in the event that the produced target image is a person's image, the feature region detecting unit 21 executes face image recognition processing or the like, thereby detecting the person's face, and also determining a region making up the eye, mouth, or the like that are feature portions within the face.

In step S42, the feature region detecting unit 21 extracts a feature region based on the analysis results in step S41. At this time, for example, information for determining, such as the eye, mouth, or the like, the feature region thereof, information such as the coordinate position and area of the determined region are obtained as the information of the extracted feature region. For example, in FIG. 3, the region of the eye indicated with a frame 101 is extracted as a feature region.

Note that the user may specify a feature region. In this case, as a region specified by the user, for example, the region of the eye indicated with the frame 101 in FIG. 3 is extracted as a feature region.

The feature region detecting unit 21 supplies the information of the feature region thus extracted to the scale determining unit 22.

In step S43, the scale determining unit 22 detects the size of the feature region extracted in the processing in step S42. Here, the size is, for example, the number of pixels in the vertical direction and horizontal direction of the extracted feature region.

In step S44, the scale determining unit 22 reads out, based on the information for determining the feature region, the layout method of the block corresponding to the feature region thereof from the feature region database 24. As described above, the layout method of the block corresponding to the feature region is stored in the feature region database 24. For example, information of “horizontally 320×4, vertically 240×2” corresponding to the feature region of the eye is stored in the feature region database 24.

In step S45, the scale determining unit 22 determines an enlargement or reduction ratio based on the size of the feature region detected in the processing in step S43, and the information read out in the processing in step S44 (layout method of the block).

At this time, the scale determining unit 22 obtains, for example, such as described above, the change ratio Va in the vertical direction, and the change ratio Ha in the horizontal direction by Expressions (1) and (2), and calculates the enlargement or reduction ratio of the feature region. Subsequently, the scale determining unit 22 determines, based on the enlargement or reduction ratio of feature region thus obtained, the enlargement or reduction ratio of the whole of the produced target image.

The scale determining unit 22 supplies the enlargement or reduction ratio of the whole of the produced target image to the image generating unit 23.

In step S46, the image generating unit 23 enlarges or reduces the produced target image in accordance with the enlargement or reduction ratio determined in the processing in step S45. Thus, the preparation processing for image generation is executed.

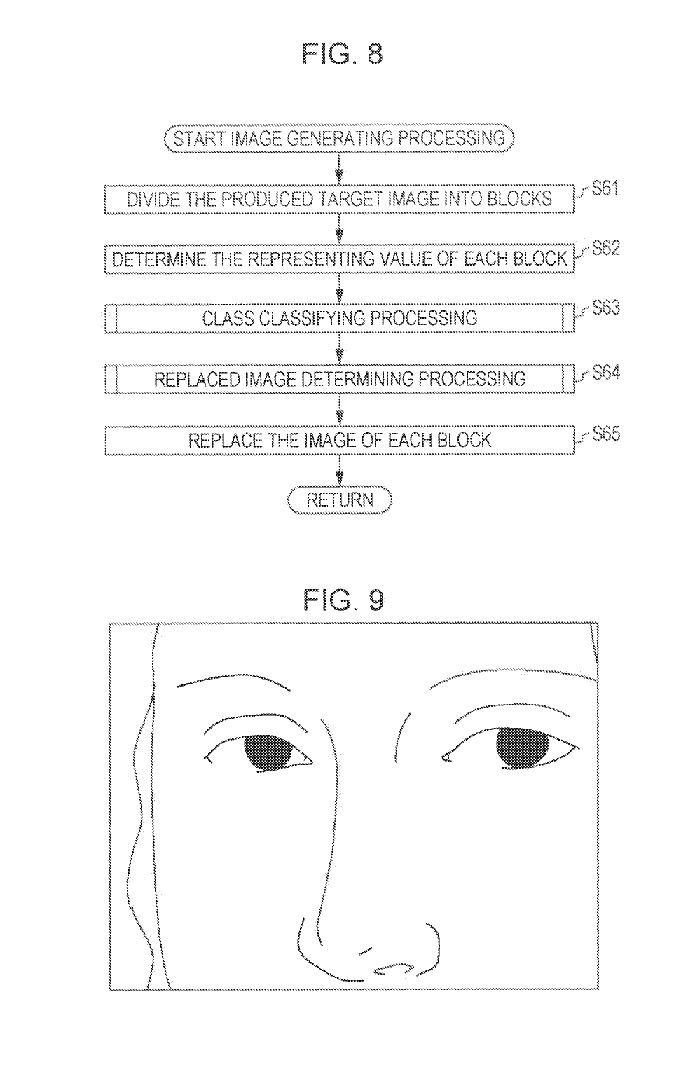

Next, a detailed example of the image generating processing to be executed in step S22 in FIG. 6 will be described with reference to the flowchart in FIG. 8.

In step S61, the block dividing unit 31 of the photomosaic image generating unit 30 divides the produced target image enlarged or reduced through the processing in step S21 in FIG. 6 into blocks. At this time, the block dividing unit 31 divides the produced target image into rectangular blocks made up of horizontally 320 pixels and vertically 240 pixels, for example.

In step S62, the representing value determining unit 62 determines the representing value of each block divided in the processing in step S61. Here, for example, the representing value may be a mean value of the pixel value of the block thereof, or may be the pixel value at the coordinate position of the center of the block thereof. Alternatively, the mean value of the pixel value of the coordinate position determined beforehand within the block thereof may be the representing value.

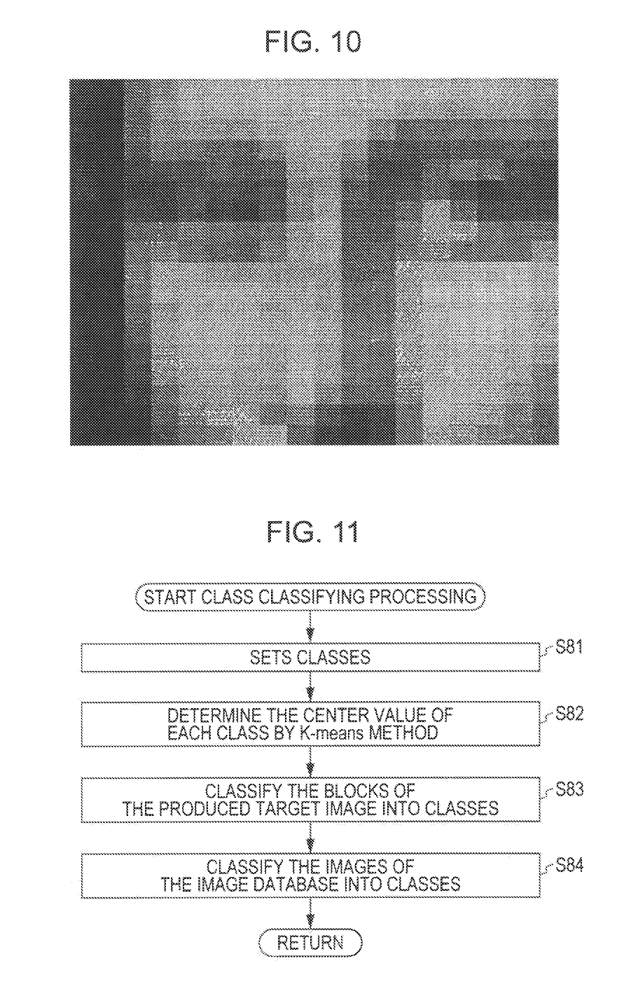

FIGS. 9 and 10 are diagrams for describing block division and determination of representing values.

For example, in the event that an image such as illustrated in FIG. 9 has been input as the produced target image, with the processing in step S61, the image illustrated in the drawing is divided into rectangular blocks made up of horizontally 320 pixels and vertically 240 pixels. In this case, the image such as illustrated in FIG. 9 that is the image of a person's face is determined to be the produced target image.

Subsequently, with the processing in step S62, the representing value of each block is determined. FIG. 10 is an example of an image where each block of the produced target image is filled with a pixel having the representing value of each block. Such as illustrated in the drawing, the image of the person illustrated in FIG. 9 is divided into rectangular blocks.

The processing returns to FIG. 8, wherein in step S63, the produced target image class classifying unit 34 and the image database class classifying unit 37 execute class classifying processing. At this time, the class center value calculating unit 33, produced target image class classifying unit 34, and image database class classifying unit 37 classify, based on the representing value of each block determined in the processing in step S62, the image of each block, and an image of the image database 51 into a class.

Now, a detailed example of the class classifying processing in step S63 in FIG. 8 will be described with reference to the flowchart in FIG. 11.

In step S81, the class center value calculating unit 33 sets classes. At this time, for example, five classes are set.

In step S82, the class center value calculating unit 33 calculates the center value of each class used for class classification, for example, by the clustering method such as the K-means method.

At this time, the class center value calculating unit 33 temporarily sets the representing values of five blocks of the edge portion of the produced target image as the center values of five classes set in the processing in step S81, respectively. Subsequently, the class center value calculating unit 33 compares the center value of each class, and the representing value, thereby classifying each block into five classes.

The class center value calculating unit 33 calculates the sum of squares of absolute values of difference of each of the RGB components of the pixel value corresponding to the center value thus temporarily set, and the pixel value corresponding to the representing value of each block to obtain distance between the center value of each class and the representing value of the block thereof. Subsequently, the class center value calculating unit 33 classifies the block thereof into a class having the shortest distance.

In this way, after a predetermined number of blocks are classified, the class center value calculating unit 33 temporarily sets the center value of each class again, for example, by calculating the mean value of the representing values of all of the blocks of each class, or the like. Subsequently, the class center value calculating unit 33 obtains distance between the center value of each class, and the representing value of each block to perform classification of the block thereof again.

The class center value calculating unit 33 executes block classification processing until the number of times of execution reaches a predetermined number of times, for example. Subsequently, the class center value calculating unit 33 determines a value obtained by calculating the mean value of the representing values of all of the blocks of each class, or the like to be the final center value of each of the classes.

With the processing in step S82, for example, the center value of each class is determined in this way.

In step S83, the produced target image class classifying unit 34 classifies, based on the center value of each class determined in the processing in step S82, the image of each block divided in the processing in step S61 into a class. Classification by the produced target image class classifying unit 34 is performed by obtaining distance between the center value of each class, and the representing value of each block in the same way as with the above case, for example.

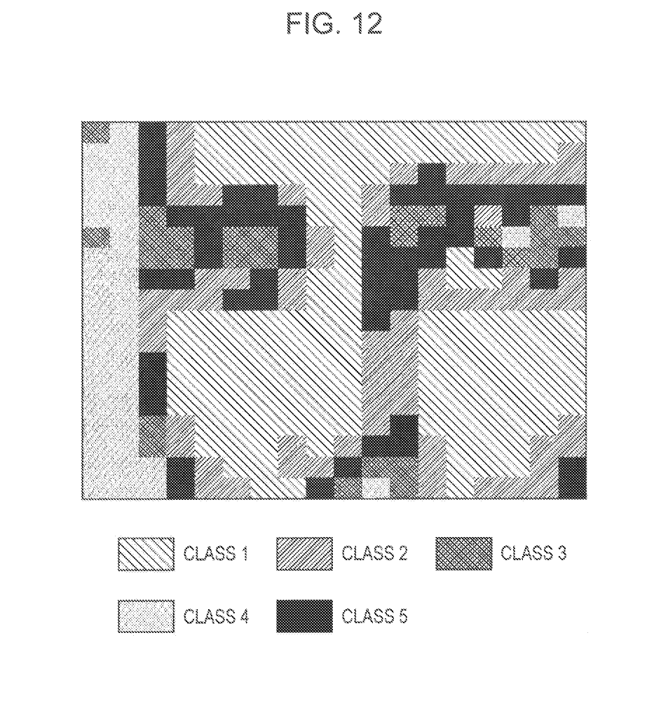

Thus, for example, such as illustrated in FIG. 10, each block of the image divided into blocks is classified into a class such as illustrated in FIG. 12. FIG. 12 is an image illustrating an example where each of the blocks illustrated in FIG. 10 is classified into a class through the processing in step S83.

In this drawing, the classes of each block are represented with a hatching pattern in the drawing. With the example in the drawing, each block of the produced target image is classified into five classes of class 1 through class 5.

In step S84, the image database class classifying unit 37 classifies, based on the center value of each class determined in the processing in step S82, an image of the image database 51 into a class, for example.

At this time, the image database class classifying unit 37 performs class classification, for example, in the same way as with the above case, by obtaining distance between the center value of each class, and the representing value of each image of the database. However, with the processing in step S84, in the event that the distance between the center value of the closest class, and the representing value of each image of the database exceeds a threshold, the image thereof is not classified into any class.

Note that, such as described above, the threshold used for classification by the image database class classifying unit 37 is changed according to the number of classified images, for example. Thus, in the event that the number of images classified into a predetermined class is excessively small, or the like, the number of the images classified into the class thereof can be increased by increasing the threshold.

The image classified into a class in the processing in step S84 is stored in the cumulative memory 38 in a manner correlated with each of the classified classes. Thus, the class classifying processing is executed.

The processing returns to FIG. 8, where after the processing in step S63, in step S64 the replaced image determining unit 35 executes replaced image determining processing. Thus, the image of each block of the produced target image is replaced with an image of the image database 51, and a photomosaic image is generated.

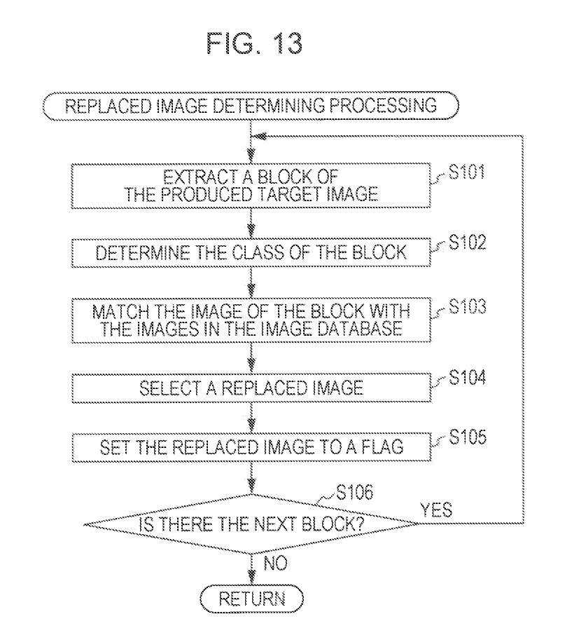

Now, a detailed example of the replaced image determining processing in step S64 in FIG. 8 will be described with reference to the flowchart in FIG. 13.

In step S101, the replaced image determining unit 35 extracts one block of the blocks of the produced target image.

In step S102, the replaced image determining unit 35 determines the class classified by the processing in step S63 regarding the extracted block in step S101.

In step S103, the replaced image determining unit 35 matches the image of this block, and the image group of the class determined in the processing in step S102 which are images read out from the image database 51 and stored in the cumulative memory 38.

At this time, for example, matching processing is executed by the following calculation. For example, such as described above, calculation of Δc is performed by calculating Expression (3), and calculation of C is performed by calculating Expression (4). That is to say, Δc calculated by Expression (3) is totaled for the worth of all of the pixels within the block.

Note that calculations of Expressions (3) and (4) may be performed after thinning the pixels of the block of the produced target image, and the pixels of the image database. Thus, for example, the amount of calculation can be reduced, and the processing time can also be reduced.

Subsequently, such matching is performed regarding each of images belonging to the class determined in the processing in step S102, and the value of C calculated by Expression (4) is stored in a manner correlated with an image stored in the cumulative memory 38.

In step S104, the replaced image determining unit 35 selects an image to be pasted on this block based on the processing result in step S103.

At this time, for example, the replaced image determining unit 35 compares the size of the value of C regarding each of the images stored in the cumulative memory 38. Subsequently, the replaced image determining unit 35 determines an image where the value of the above C is the smallest to be an image to be pasted (replaced) on this block, for example.

In step S105, the replaced image determining unit 35 sets the image selected in the processing in step S104 to a flag. Thus, with the subsequent processing in step S103, matching is performed with the image to which the flag has been set being excluded.

For example, of the images stored in the cumulative memory 38, an image of which the flag has not been set is determined to be a replaced image until the flag is set to all of the images classified into the same class. In the event that the flag is set to all of the images classified into the same class, the flags of the images of this class are all cleared.

In step S106, the replaced image determining unit 35 determines whether or not there is the next block. That is to say, determination is made whether or not there is any block of the reproduced target image of which the replaced image has not been determined (selected).

In the event that determination is made in step S106 that there is the next block, the processing returns to step S101, where the subsequent processing is repeatedly executed.

In the event that determination is made in step S106 that there is no next block, the replaced image determining processing ends.

Note that an example has been described here wherein a replaced image is determined so that the same image is not redundantly used by the flag being set thereto, but the same image may not redundantly be used by the constraint in the vicinity of N described with reference to FIG. 5. Thus, the replaced image determining processing is executed.

The processing returns to FIG. 8, where after the processing in step S64, in step S65 the image replacing unit 36 replaces the image selected in the processing in step S104 with the image of this block. In this way, all of the blocks of the image are replaced with the image selected in the processing in step S104, and accordingly, a photomosaic image is generated.

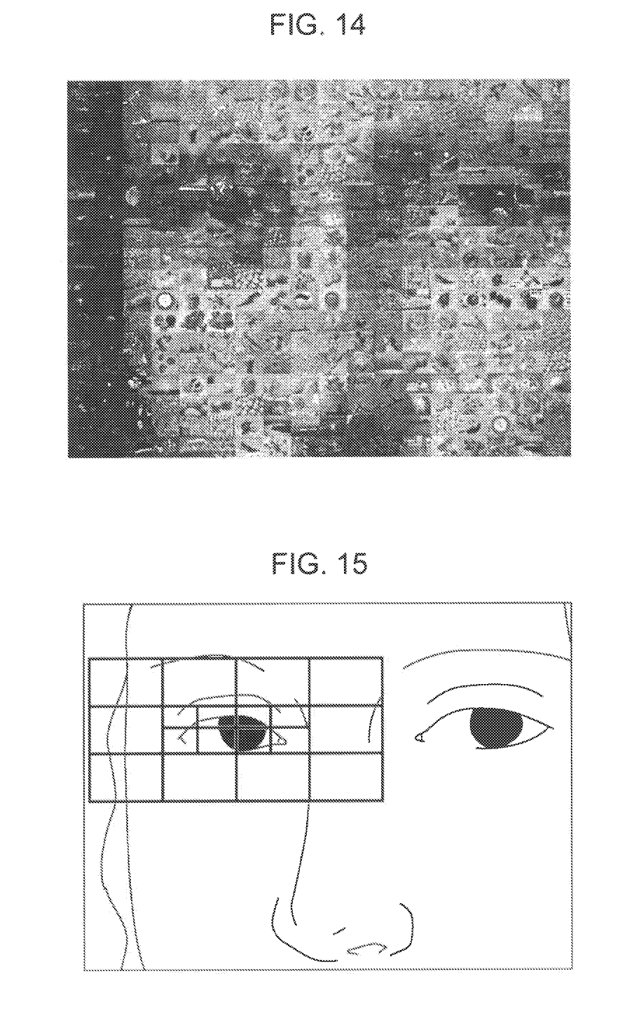

Thus, for example, a photomosaic image such as illustrated in FIG. 14 is generated. FIG. 14 is a diagram illustrating an example of a photomosaic image corresponding to the produced target image in FIG. 9.

That is to say, the produced target image illustrated in FIG. 9 is divided into blocks such as illustrated in FIG. 10, and are classified into a class such as illustrated in FIG. 12. Subsequently, matching between the image of each block, and the image of a classified class is performed, and the image of each block is replaced with an image of the image database 51. In this way, a photomosaic image such as illustrated in FIG. 14 is generated from the produced target image illustrated in FIG. 9. Thus, the image generating processing is executed.

With the preparation processing for image generation described above with reference to FIG. 7, description has been made wherein the produced target image is enlarged or reduced, but a block may be enlarged or reduced instead of the produced target image. In this case, an image stored in the image database 51 should also be enlarged or reduced in accordance with the size of the block.

Specifically, the scale determining unit 22 determines, based on the inverse number of the enlargement or reduction ratio of a feature region for example, the enlargement or reduction ratio of the block. Subsequently, the image generating unit 23 outputs the produced target image without changing its original size, and also supplies the above enlargement or reduction ratio of the block to the photomosaic image generating unit 30. The photomosaic image generating unit 30 enlarges or reduces the size of the block using the supplied enlargement or reduction ratio of the block, and also enlarges or reduces each of the images obtained from the image database 51 using the enlargement or reduction ratio of the block.

Also, description has been made wherein in step S61 in FIG. 8, the produced target image is divided into rectangular blocks made up of horizontally 320 pixels and vertically 240 pixels, but the produced target image may not be divided into the same sized rectangular blocks.

For example, the feature region detected by the feature region detecting unit 21 may be divided into smaller sized blocks.

FIG. 15 is a diagram illustrating another example in the event that the produced target image illustrated in FIG. 9 is divided into blocks. In the case of this drawing, only the image of the eye that is a feature region is divided into smaller sized blocks than those of a peripheral image thereof. That is to say, the image of the eye portion in FIG. 15 is divided into blocks of ¼ of the size of a peripheral image thereof.

Thus, with an image generated as a photomosaic image, for example, the texture of the image of a feature portion such as the eye of a person's face or the like can be expressed more in detail. As a result thereof, a photomosaic image can be generated, for example, such that in the event that an observer views the image from a distance, the observer is given an impression closer to the produced target image.

Further, description has been made in the processing in step S65 in FIG. 8 wherein a photomosaic image is generated by the images of all of the blocks being replaced with the image selected in the processing in step S104, but the images of all of the blocks do not have to be replaced.

For example, in the event that of the values of C calculated as results of the processing in step S103, the minimum thereof exceeds the threshold, the image of the block thereof may not be replaced without being changed from the image of the block thereof of the original produced target image. Thus, for example, according to no suitable image to be replaced existing in the image database 51 as the image of a predetermined block, the quality of the photomosaic image can be prevented from deteriorating.

Also, with the above example, description has been made wherein the same image is prevented from being redundantly used as much as possible, but similar images may be prevented from being adjacently disposed, for example.

For example, in the event that similar images are pasted on adjacent blocks, the same optical effect as with the case where the same image is redundantly used may be effective. In order to prevent similar images from being pasted on adjacent blocks, for example, an arrangement may be made wherein the replaced image determining unit 35 calculates similarity between an image to be pasted on adjacent blocks and an image to be pasted on this block, only the image of which the similarity is less than a threshold is taken as a replaced image. Note that, with the similarity of images, values to be obtained by the block matching method may be employed.

Further, with the above example, description has been made regarding an example wherein an image to be pasted on a block is principally obtained from the image database 51, but may be obtained from the server 53 via the network 52, for example.

Alternatively, only an image that is unable to be obtained from the image database 51 may be obtained from the server 53.

For example, as a result of class classification by the image database class classifying unit 37, in the event that the number of images classified into class 3 is small, a request packet for an image of class 3 is transmitted from the photomosaic image generating device 10 to the server 53. At this time, for example, the center value and threshold of class 3 are transmitted in a manner included in the request packet. Also, the information of a tag representing the number of images to be used, the type of an image (e.g., type such as a flower image, mountain image, person image, or the like), or the like may be included in a request packet.

Subsequently, the server 53 classifies an image to be stored by itself into a class in the same way as the image database class classifying unit 37, and transmits the image classified into class 3 to the photomosaic image generating device 10 via the network 52.

Thus, a further high-quality photomosaic image can be generated.

Description has been made so far regarding an example wherein the photomosaic image generating device 10 is configured of the produced target image processing unit 20 and the photomosaic image generating unit 30, but other configurations may be employed instead of this.

For example, a device which realizes the function of the produced image processing unit 20 may be connected to the photomosaic image generating device according to the related art.

As described above, the produced target image may automatically be reduced or enlarged by the produced target image processing unit 20 based on the feature region of the produced target image, and the size of blocks. Accordingly, even when the produced target image processing unit 20 is used standalone, an advantage can be expected wherein a beautiful photomosaic image can be generated in a small amount of time without special skills or the like.

Also, for example, a photomosaic image may be generated using a device alone which realizes the function of the photomosaic image generating device 30 without providing the produced target image processing unit 20.

That is to say, even when the photomosaic image generating unit 30 is used standalone, an advantage can be expected wherein, with the generated photomosaic image, the texture of the produced target image can be expressed, and also the amount of calculation and the processing time can be reduced. Also, for example, an advantage can be expected wherein the same image can be prevented from being redundantly used as much as possible.

Further, the photomosaic image generating device 10 may be configured so as to be housed in an imaging apparatus. Also, the produced target image, and the images to be stored in the image database 51 may be any kind of image, for example, such as an image obtained by scanning a photo or picture through a scanner, CG (Computer Graphics), and so forth.

Further, description has been made so far wherein, with class classification by the image database class classifying unit 37, an image serving as a material is classified into a predetermined number of classes, but the number of classes may adaptively be changed. For example, a histogram of the representing value of an image stored in the image database 51 is generated, and the number of classes may be changed based on the discrete value of the histogram thereof.

Thus, for example, even when the ratio of red pixels is high in all of the images to be stored in the image database 51, or the like, generation of a suitable photomosaic image may be performed without unnatural class classification being performed.

Alternatively, for example, the number of classes may adaptively be changed based on the discrete value of the histogram of the representing value of the produced target image.

Also, the produced target image processing unit 20 and photomosaic image generating unit 30 in FIG. 1 may be configured so as to be connected via the network. Subsequently, for example, an arrangement may be made wherein a photomosaic image generating command is transmitted via the network, a photomosaic image is generated by the server connected to the network, or the like, and is transmitted to a cell phone.

That is to say, each function block of the photomosaic image generating device 10 according to an embodiment of the present invention may be realized, for example, by an arbitrary number of servers to be connected via the network.

Incidentally, with an image stored in the image database 51 (or server 53), the information of a tag representing the type of the image (e.g., type such as a flower image, mountain image, person image, etc.) or the like may be added thereto. Thus, an image to be pasted on each block may be selected using the tag.

For example, let us consider a case where a photomosaic image is generated as a material of an image stored in the image database 51 in which a family photo is stored. In this case, let us say that a tag of “father”, “mother”, “elder brother”, or “elder sister” is added to the images stored in the image database 51. Subsequently, let us say that the father, mother, elder brother, or elder sister is taken on an image to which the tag of “father”, “mother”, “elder brother”, or “elder sister”, as a subject.

In such a case, the user may specify a ratio where the father, mother, elder brother, or elder sister is taken of images serving as a material of the generated photomosaic image, for example. That is to say, an arrangement may be made wherein, based on the tags of the images stored in the image database 51, an image to be pasted on each block is selected from any one of the father, mother, elder brother, and elder sister, and an image on which the father, mother, elder brother, or elder sister is taken is pasted on each block with the ratio specified by the user.

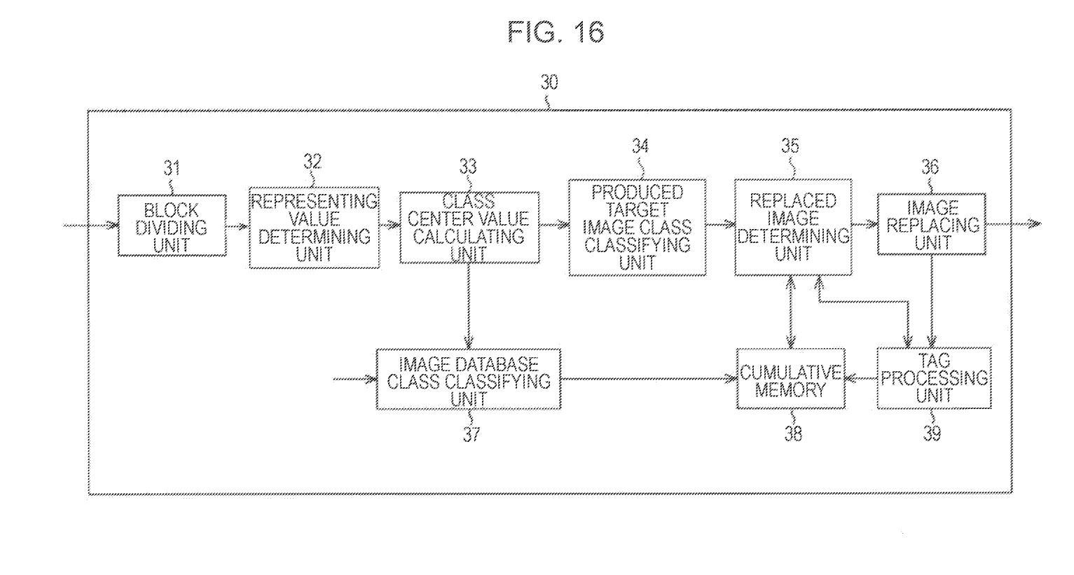

FIG. 16 is a block diagram illustrating a configuration example of the photomosaic image generating unit 30 in the event that an image to be pasted on each block is selected using a tag.

With the example in this drawing, unlike the case in FIG. 4, a tag processing unit 39 is provided. Other configurations in FIG. 16 are the same as with the case of FIG. 4, and accordingly, detailed description thereof will be omitted.

In the case of the configuration in FIG. 16, the replaced image determining unit 35 matches, in the same way as the case of the configuration in FIG. 4, the image of a block classified into a class by the produced target image class classifying unit 34, and the image group of the class of the block thereof which are images stored in the cumulative memory 38. Subsequently, the replaced image determining unit 35 determines, for example, an image where the value of the above C is the minimum value to be an image to be pasted (replaced) on this block. The replaced image determining unit 35 supplies the image thus determined to the image replacing unit 36.

At this time, unlike the case of the configuration in FIG. 4, the replaced image determining unit 35 supplies the images of the image group of the class of the block thereof to the tag processing unit 39 as candidate images. Here, the candidate images are images serving as a candidate of an image to be pasted on the block thereof, such as an image where the value of the above C is the smallest value, an image where the value of the above C is the second smallest value, an image where the value of the above C is the third smallest value, and so on. The candidate images are supplied to the tag processing unit 39 in a manner correlated with information for determining this block. Note that of the candidate images, the image where the value of the above C is the smallest value becomes an image to be pasted on each block of a photomosaic image by the processing of the image replacing unit 36 for the first time.

The candidate images do not have to include image data itself, and may be configured of, for example, an identification number for determining an image, and information for determining the value of C and a block.

The tag processing unit 39 accepts supply of the above candidate images, and also accepts supply of a photomosaic image generated through the processing of the image replacing unit 36.

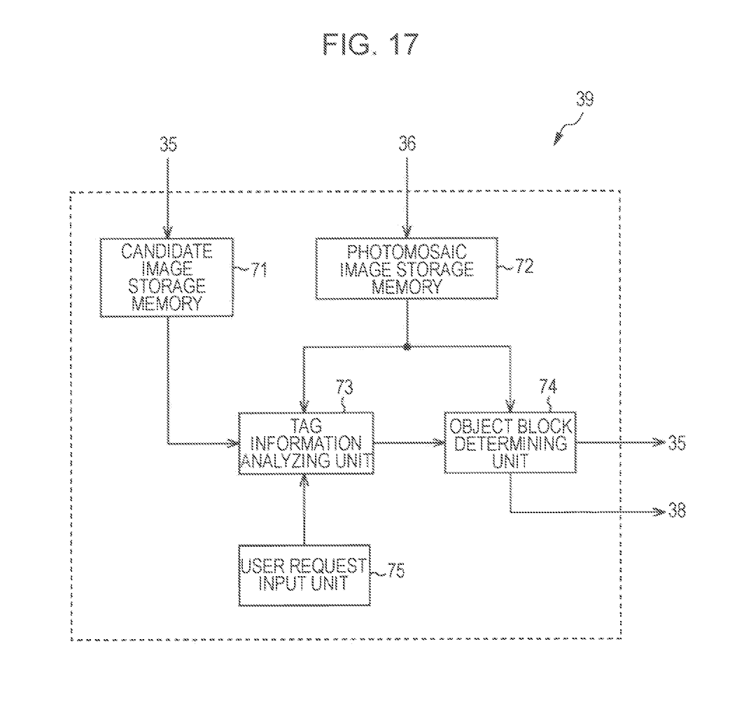

FIG. 17 is a block diagram illustrating a detailed configuration example of the tag processing unit 39 in FIG. 16. Such as illustrated in this drawing, with the tag processing unit 39, a candidate image storage memory 71, a photomosaic image storage memory 72, a tag information analyzing unit 73, an object block determining unit 74, and a user request input unit 75 are provided.

The candidate images supplied from the replaced image determining unit 35 are stored in the candidate image storage memory 71 in a manner correlated with the value of the above C, and information for determining this block. Also, the photomosaic image generated through the processing of the image replacing unit 36 is stored in the photomosaic image storage memory 72.

The tag information analyzing unit 73 of the tag processing unit 39 analyzes the tag of an image pasted on each block of the photomosaic image generated through the processing of the image replacing unit 36 to determine how much images of which the type is represented with such a tag have been pasted. Subsequently, the tag information analyzing unit 73 calculates the ratio of blocks on which an image to which a predetermined tag is added is pasted of the number of all of the blocks of the photomosaic image, for example.

The user request input unit 75 is configured to accept a specification by the user of the ratio of images to which a predetermined tag is added.

The object block determining unit 74 compares the ratio calculated by the tag information analyzing unit 73, and the ratio specified by the user via the user request input unit 75. Subsequently, the object block determining unit 74 determines a block of which the image should be replaced again so that the ratio of the blocks on which an image to which a predetermined tag is added is pasted is matched with the ratio specified by the user.

For example, with the above example, let us say that of the images serving as a material of the generated photomosaic image, the user has specified ratios where the father, mother, elder brother, or elder sister is taken, respectively, e.g., let us say that the user has specified the ratios of the images of the father, mother, elder brother, and elder sister to 25%, respectively.

The ratios of images pasted on each block of the photomosaic image first generated through the processing by the image replacing unit 36 are, for example, 25% of father's images, 15% of mother's images, 25% of elder brother's images, and 35% of elder sister's images.

In this case, the object block determining unit 74 determines the blocks of the elder sister's images pasted at a higher ratio than the specified ratio. Subsequently, the object block determining unit 74 references the candidate image storage memory 71 to sort the elder sister's image pasted on each block in the descending order of the value of C.

The object block determining unit 74 determines a block in which an image other than the elder sister's image as the second candidate image, which is a block on which an image of which the value of C is great is pasted. That is to say, of the blocks of the elder sister's images of the photomosaic image first generated, a block on which an image of which the value of C is the second smallest value is the father, mother, or elder brother is determined. The object block determining unit 74 determines the block thus determined to be an object block of which the image should be replaced again, and supplies the information determining the determined object block to the replaced image determining unit 35.

The object block determining unit 74 performs determination of a block (object block) where such an image should be replaced in order from a block where an image having a greater value of C is pasted (an image of which the suitability is low). For example, in the event that the elder sister's images have to be reduced by three images to match with the ratio specified by the user, determination of a block where an image other than the elder sister's image is stored as the second candidate image is performed until three object blocks are determined.

For example, let us say that of all of the blocks of the first generated photomosaic image, there are five blocks of a block A through a block E where the elder sister's image is pasted. Let us say that the value of C of the image pasted on the block A (value representing suitability) is 5, the value of C of the image pasted on the block B is 4, and similarly, the values of C of the images pasted on the blocks C through E are 3, 2, and 1, respectively. Note that in this case, description has been made on the premise that the higher the value of C is, the higher the suitability of the image is, but for example, in the event that the inverse number of C is employed as the value of suitability, the higher the value is, the higher the suitability of the image is.

The object block determining unit 74 checks the candidate images in order from a block of which the suitability is lower. In this case, the candidate images correlated with the block A are first checked. Let us say that of the candidate images correlated with the block A, the first candidate image is the elder sister's image where the value of C is 5, and the second candidate image is the mother's image where the value of C is 6. In this case, the object block determining unit 74 determines the block A to be an object block. This is because the second candidate image of the block A is an image other than the elder sister's image.

Next, the object block determining unit 74 checks the candidate images correlated with the block B. Let us say that of the candidate images correlated with the block B, the first candidate image is the elder sister's image where the value of C is 4, and the second candidate image is the elder sister's image where the value of C is 7. In this case, the object block determining unit 74 does not determine the block B to be an object block. This is because the second candidate image of the block B is the elder sister's image.

Next, the object block determining unit 74 checks the candidate images correlated with the block C. Let us say that of the candidate images correlated with the block C, the first candidate image is the elder sister's image where the value of C is 3, and the second candidate image is the father's image where the value of C is 7. In this case, the object block determining unit 74 determines the block C to be an object block. This is because the second candidate image of the block C is an image other than the elder sister's image.

Next, the object block determining unit 74 checks the candidate images correlated with the block D. Let us say that of the candidate images correlated with the block D, the first candidate image is the elder sister's image where the value of C is 2, and the second candidate image is the mother's image where the value of C is 5. In this case, the object block determining unit 74 determines the block D to be an object block. This is because the second candidate image of the block D is an image other than the elder sister's image.

Thus, the three of the blocks A, C, and D have been determined to be an object block, and accordingly, check of the candidate images of the block E is not performed.

Note that, for example, an arrangement may be made wherein the object block determining unit 74 determines an object block of which the image is replaced again, and also eliminates the image of a predetermined tag currently pasted on the photomosaic image. For example, in the event that the elder sister's image is replaced again such as described above, of the elder sister's images stored in the cumulative memory 38, the elder sister's image already used as a material of the photomosaic image may be eliminated.

Thus, for example, an image serving as a material can be prevented from being redundantly employed, and also the processing load can be reduced by reducing the amount of memory to be used.

Thus, the replaced image determining unit 35 determines an image to be pasted again on a block corresponding to the information supplied from the object block determining unit 74. At this time, of the images of the class of the block thereof, an image where the value of the above C is the second smallest value is determined to be an image to be pasted (replaced) on this block.

Subsequently, the image replacing unit 36 replaces the image of this block with the image supplied from the replaced image determining unit 35. In this case, of the blocks of the once generated photomosaic image, the images of the three blocks where the elder sister's image is pasted are replaced. In this way, the photomosaic image of which the images have been replaced again is supplied to the tag processing unit 39 again.

Thus, the tag processing unit 39 determines a block of which the image should be replaced again so that the ratio of blocks where an image to which a predetermined tag is added is pasted is matched with the ratio specified by the user, such as described above.

A photomosaic image is generated by repeating such processing such that the ratio of blocks where an image to which a predetermined tag is added is pasted is matched with the ratio specified by the user. Note that it can be conceived that there is a low possibility that the above ratio accurately converges with the ratio specified by the user, and actually, an upper limit may be provided to the number of times of repetition.

Note that description has been made here wherein the photomosaic image generated through the processing by the image replacing unit 36 is stored in the photomosaic image storage unit 72, but the photomosaic image storage unit 72 may be omitted. In this case, a photomosaic image should virtually be generated based on the candidate images.

As described above, the candidate images are images serving as an image candidate to be pasted on the block thereof, which are an image where the value of the above C is the smallest value, an image where the value of the above C is the second smallest value, an image where the value of the above C is the third smallest value, and so on. Accordingly, the image where the value of C is the smallest value becomes an image to be pasted on each block of the first generated photomosaic image.

In this way, a photomosaic image is virtually generated based on the candidate images, whereby an image pasted on each block of the generated photomosaic image can be determined. Subsequently, as described above, the tag information analyzing unit 73 analyzes the tag of an image pasted on each block of the virtually generated photomosaic image to determine how much each of the images of the types represented with these tags is pasted.

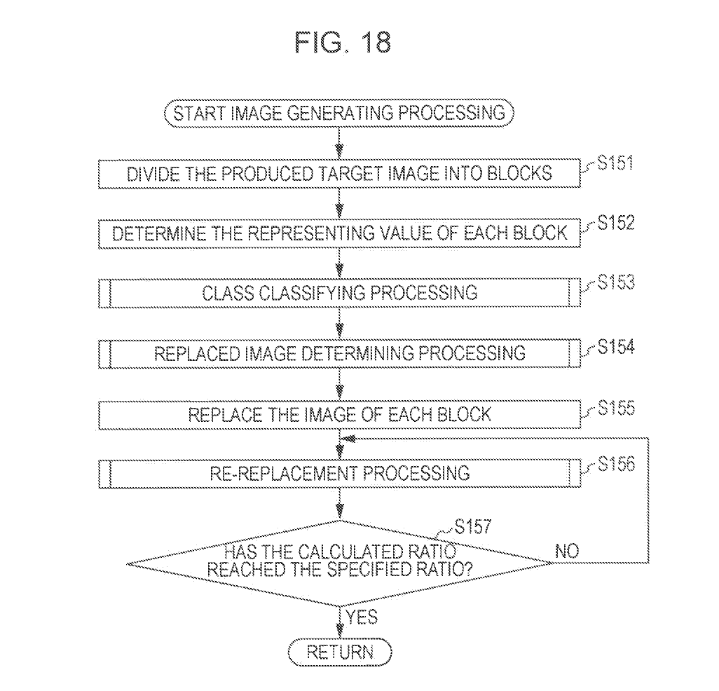

A detailed example of the image generating processing to be executed in step S22 in FIG. 6 in the event that the photomosaic image generating unit 30 is configured such as illustrated in FIG. 16 is such as illustrated in the flowchart in FIG. 18.

Steps S151 through S155 in FIG. 18 are the same processing as steps S61 through S65 in FIG. 8, and accordingly, detailed description thereof will be omitted. However, in the case of FIG. 18, with replaced image determining processing in step S154, the replaced image determining unit 35 supplies the images of the image group of the class of the block thereof to the tag processing unit 39 as the candidate images. Here, the candidate images are images serving as a candidate of an image to be pasted on the block thereof, such as an image where the value of the above C is the smallest value, an image where the value of the above C is the second smallest value, an image where the value of the above C is the third smallest value, and so on. The candidate images are supplied to the tag processing unit 39 in a manner correlated with information for determining this block.

The tag processing unit 39 accepts supply of the above candidate images, and also accepts supply of a photomosaic image generated through the processing in step S155 of the image replacing unit 36.

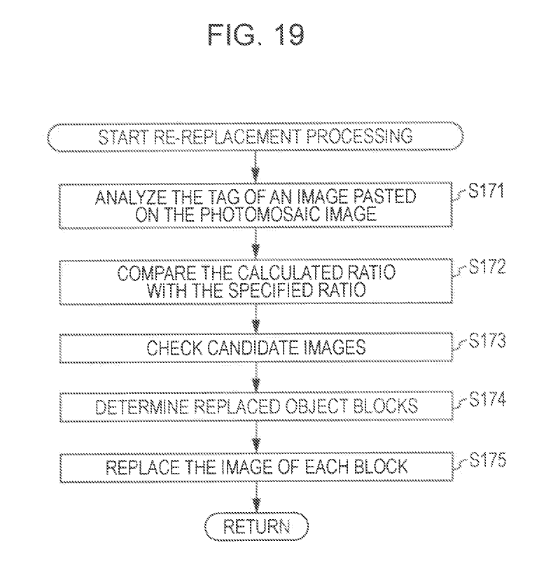

With the processing in FIG. 18, after the processing in step S155, re-replacement processing is executed in step S156. Now, a detailed example of the re-replacement processing in step S156 in FIG. 18 will be described with reference to the flowchart in FIG. 19.

In step S171, the tag information analyzing unit 73 analyzes the tag of an image pasted on each block of the photomosaic image generated through the processing in step S155 of the image replacing unit 36 to determine how much images of which the type is represented with such a tag have been pasted. Subsequently, the tag information analyzing unit 73 calculates the ratio of blocks on which an image to which a predetermined tag is added is pasted of the number of all of the blocks of the photomosaic image, for example.

In step S172, the object block determining unit 74 compares the ratio calculated in the processing in step S171 by the tag information analyzing unit 73, and the ratio specified by the user via the user request input unit 75. Subsequently, the object block determining unit 74 determines a block of which the image should be replaced again so that the ratio of the blocks on which an image to which a predetermined tag is added is pasted is matched with the ratio specified by the user.

In step S173, the object block determining unit 74 checks the candidate images stored in the candidate image storage memory 71. In step S174, the object block determining unit 74 determines an object block of which the image is replaced again.

At this time, for example, as described above, the value of C of the elder sister's images pasted on the blocks with the higher ratio than the specified ratio is sorted in the descending order. Subsequently, a block where an image other than the elder sister's images is stored as the second candidate image, which is a block where an image of which the value of C is great is pasted, is determined. The block thus determined is determined to be a block of which the image should be replaced again, and information for determining the determined block (object block) is supplied to the replaced image determining unit 35.

In step S175, the replaced image determining unit 35 and the image replacing unit 36 replace the image of each block determined in the processing in step S174.

At this time, the replaced image determining unit 35 determines an image to be pasted again on the block corresponding to the information supplied from the object block determining unit 74. At this time, of the images of the class of the block thereof, an image where the value of the above C is the second smallest value is determined to be an image to be pasted (replaced) on this block. Note that the image to be pasted on this block is determined based on the information stored in the candidate image storage memory 71. The image replacing unit 36 replaces the image of this block with the image supplied from the replaced image determining unit 35. Thus, the re-replacement processing is executed.

The processing returns to FIG. 18, where after the processing in step S156, the processing proceeds to step S157.

In step S157, the object block determining unit 74 determines whether or not the ratio calculated by the tag information analyzing unit 73 is matched with the ratio specified by the user via the user request input unit 75.

That is to say, the photomosaic image where the image is replaced again by the processing in step S156 is supplied to the tag processing unit 39 again. Subsequently, the tag information analyzing unit 73 analyzes the tag of an image pasted on each block of the photomosaic image generated through the processing in step S175 of the image replacing unit 36 to determine how much images of which the type is represented with such a tag have been pasted. Subsequently, the tag information analyzing unit 73 calculates the ratio of blocks on which an image to which a predetermined tag is added is pasted of the number of all of the blocks of the photomosaic image, for example.

In the event that determination is made in step S157 that the ratio calculated by the tag information analyzing unit 73 is not matched with the ratio specified by the user via the user request input unit 75, the processing returns to step S156. Subsequently, the above re-replacement processing is repeatedly executed.

In the event that determination is made in step S157 that the ratio calculated by the tag information analyzing unit 73 is matched with the ratio specified by the user via the user request input unit 75, the image generating processing ends. Note that, as described above, the image generating processing may end at the time of the number of times of repetition reaching the upper limit. Thus, the image generating processing is executed.

Note that, for example, an arrangement may be made wherein in step S174, the object block determining unit 74 determines an object block where the image is replaced again, and also eliminates the image of a predetermined type currently pasted on the photomosaic image from the cumulative memory 38. Thus, for example, an image serving as a material can be prevented from being redundantly employed, and also the processing load can be reduced by reducing the amount of memory to be used.

Also, as described above, the same image may be prevented from being redundantly used by setting a predetermined flag to the images stored in the cumulative memory 38, or the constraint in the vicinity of N may be imposed.

Thus, according to an embodiment of the present invention, for example, the user's desired image can be used as a photomosaic image within the images of the image database. Also, the user can specify the ratio of predetermined type of images to be used while preventing the percentage of completion of the photomosaic image from deteriorating.

Thus, for example, a photomosaic image using a family member's photo as a material without bias, a photomosaic image using the photo for each season as a material without bias can readily be generated.

Also, according to an embodiment of the present invention, an arrangement may be made wherein the ratio of blocks on which an image to which a predetermined tag is added is pasted is specified so as to become 0, and for example, it is also possible to prevent blocks on which an image to which a predetermined tag is added is pasted from being used at all. For example, while specifying a flower image to be used at a ratio of 50% in a Christmas card, reptiles may be prevented from being employed.

Further, the ratio of such image type may automatically be specified according to the purpose of a photomosaic image to be generated, such as “Christmas card”, “New Year's card”, and so on.

Note that, with the above example, the type of image is determined by a tag, but the type of image may be determined by a tag being automatically added through image processing such as subject recognition or the like.

Also, description has been made so far regarding an example of a case where the type of image is determined in response to a subject within an image principally such as a photo or the like, but the type of image may be a color image or monochrome image. Further, a moving image or still image or a photo or CG (Computer Graphics) or the like may be the type of image. Alternatively, the type of image may be determined based on such as copy right management information or the like.

Incidentally, the user who generates a photomosaic image often desires to employ his/her favorite image within a completed photomosaic image. Alternatively, many users desire to improve statement effect of a photomosaic image by employing a desired image as a region tile such as attracting an observer's eye within the photomosaic image.

Therefore, with an embodiment of the present invention, the user is allowed to use a specified image as a mosaic tile within a predetermined region.

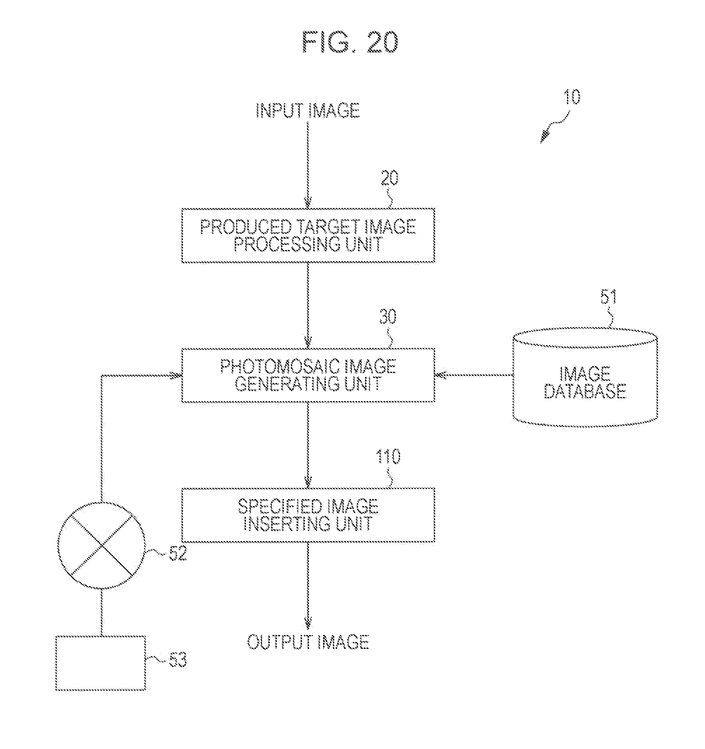

FIG. 20 is a block diagram illustrating another configuration example of the photomosaic image generating device according to an embodiment of the present invention. With the photomosaic image generating device 10 illustrated in the drawing, the user is allowed to use a specified image as a mosaic tile within a predetermined region.

FIG. 20 is a diagram corresponding to FIG. 1, wherein the function block corresponding to each portion in FIG. 1 is denoted with the same reference numeral. With the example in FIG. 20, unlike the case of FIG. 1, a specified image inserting unit 110 is provided. The configurations of other portions are the same as with the case of FIG. 1, and accordingly, detailed description thereof will be omitted.

The specified image inserting unit 110 is configured to insert an image specified by the user into a photomosaic image as the image of a mosaic tile.

The specified image inserting unit 110 is configured to accept supply of a generated photomosaic image and the produced target image from the photomosaic image generating unit 30. Note that the supplied produced target image is a produced target image divided into blocks by the block dividing unit 31.

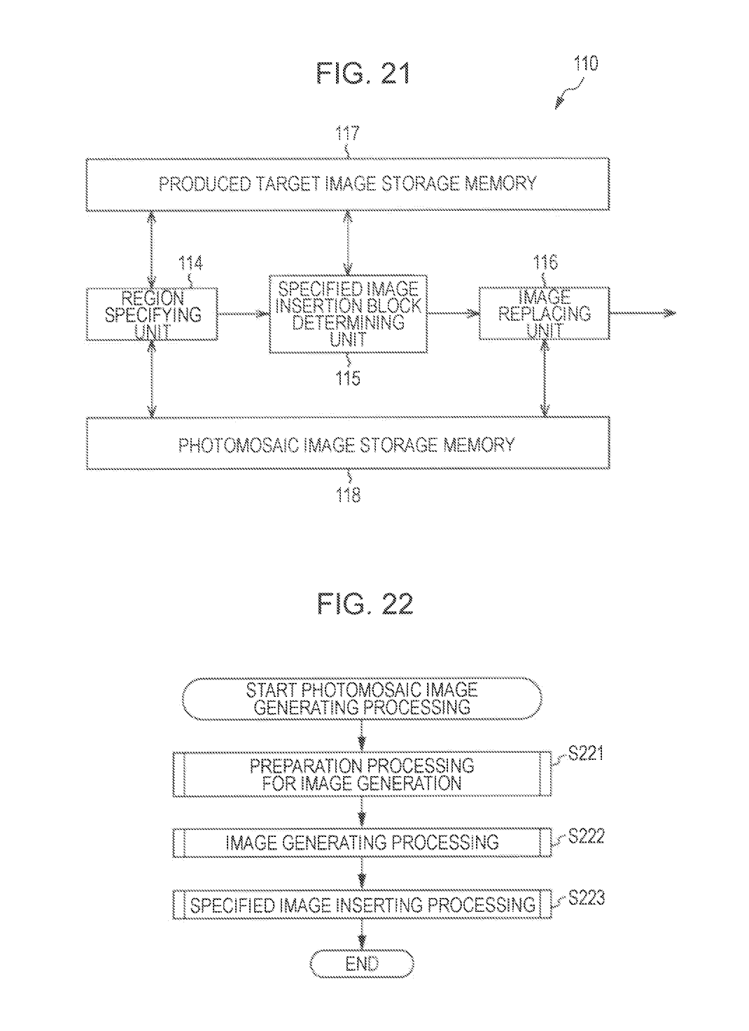

FIG. 21 a block diagram illustrating a detailed configuration example of the specified image inserting unit 110. Such as illustrated in the drawing, the specified image inserting unit 110 is configured so as to include a region specifying unit 114, a specified image insertion block determining unit 115, an image replacing unit 116, a produced target image storage memory 117, and photomosaic image storage memory 118.

The produced target image supplied from the photomosaic image generating unit 30 is stored in the produced target image storage memory 117. Also, the photomosaic image supplied from the photomosaic image generating unit 30 is stored in the photomosaic image storage memory 118.

The region specifying unit 114 is configured to accept specification of a region into which the image specified by the user (referred to as specified image) should be inserted. For example, specification of a region into which the specified image should be inserted is performed by the user selecting an arbitrary region within the photomosaic image using a predetermined pointing device.

The region specifying unit 114 correlates a region specified such as described above with a block of the produced target image to determine the block thereof.

Note that description has been made so far wherein specification of a region into which the specified image should be inserted within the photomosaic image is accepted, and the region thereof is correlated with a block of the produced target image, but specification of a region into which the specified image should be inserted within the produced target image may be accepted. Alternatively, a block into which the specified image should be inserted may directly be specified.

The specified image insertion block determining unit 115 calculates suitability as to the specified image regarding the image of each block determined through the processing of the region specifying unit 114. Calculation of suitability is performed by the same calculation as the calculation used for the matching processing in step S103 in FIG. 13, for example. The value of C calculated by the above Expression (4) is used as the suitability. That is to say, according to the above Expression (4), suitability is calculated for each block determined through the processing of the region specifying unit 114.

The suitability calculated at this time means the suitability of the specified image serving as a region for replacing the image of each block. For example, suitability to be obtained by matching the image of the block A within the produced target image and the specified image represents how the specified image is suitable as an image for replacing the image of the block A. However, in other words, it can be conceived that the suitability represents how the block A is suitable as a block into which the specified image should be inserted. That is to say, the suitability calculated by the specified image insertion block determining unit 115 may be conceived as the suitability of each block as to the specified image.

The specified image insertion block determining unit 115 determines a block where the calculated suitability is the highest (e.g., a block where the value of C is the smallest) to be a block into which the specified image should be inserted.

Now, let us say that the data of the specified image has been supplied to the specified image inserting unit 110.

The image replacing unit 116 replaces, with the photomosaic image stored in the photomosaic image storage memory 118, the image of the block determined by the specified image insertion block determining unit 115 with the specified image.

Subsequently, the photomosaic image after replacement by the image replacing unit 116 is output from the photomosaic image generating device 10 as an output image.

Thus, with the photomosaic image generating device 10 according to an embodiment of the present invention, an image specified by the user can be used as a mosaic tile within a predetermined region.

Note that the specified image is usually an arbitrary image selected by the user, and is not determined to be suitable as the image of the block of the produced target image (mosaic tile). Accordingly, when the region specifying unit 114 accepts specification of a region into which the specified image should be inserted within the photomosaic image, there is a high possibility that the greater the area of the specified region is, the more beautiful a photomosaic image can be generated. In general, there is a high possibility that the more the number of blocks serving as an object for calculating suitability is, the higher the suitability of the image of a block is.

Accordingly, when accepting specification of a region into which the specified image should be inserted, in the event that the area of the specified region is small, an unnatural photomosaic image may be generated. For example, in order to prevent the area of the specified region from becoming small, specification of a region of which the area is equal to or smaller than a predetermine area may be prevented from being accepted by the region specifying unit 114.

Alternatively, the region of a predetermined area may automatically be specified with a point specified using a predetermined pointing device as a reference. Further, alternatively, the region of an area calculated based on the number of blocks and the number of pixels of the produced target image may automatically be specified with a point specified using a predetermined pointing device as a reference.

Next, description will be made regarding an example of the photomosaic image generating processing to be executed by the photomosaic image generating device 10 illustrated in FIG. 20, with reference to the flowchart in FIG. 22.

The processing in steps S221 and S222 is the same as steps S21 and S22 in FIG. 6, and accordingly, detailed description will be omitted.

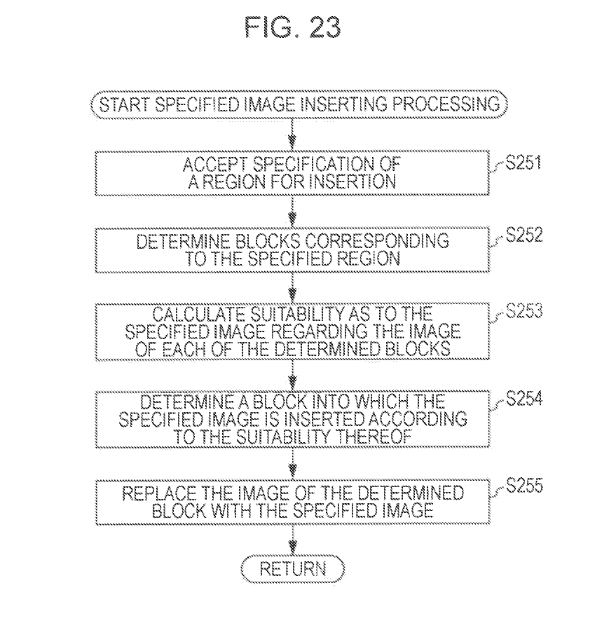

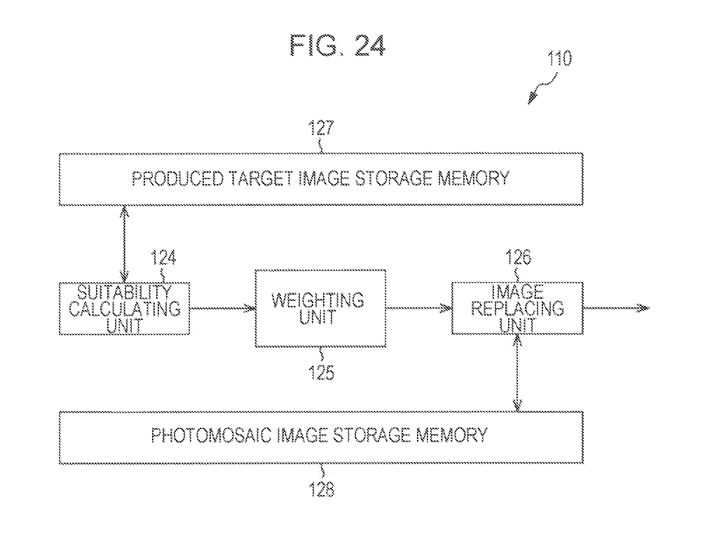

After the processing in step S222, in step S223 the specified image inserting unit 110 executes specified image inserting processing described later with reference to FIG. 23.

Now, a detailed example of the specified image inserting processing in step S223 in FIG. 22 will be descried with reference to the flowchart in FIG. 23.

In step S251, the region specifying unit 114 accepts specification of a region into which the image specified by the user should be inserted within the photomosaic image. At this time, for example, specification of a region into which the specified image should be inserted is performed, for example, by the user selecting an arbitrary region within the photomosaic image using a predetermined pointing device.

In step S252, the region specifying unit 114 correlates the region specified such as described above with a block of the produced target image to determine the block thereof.

In step S253, the specified image insertion block determining unit 115 calculates suitability as to the specified image regarding the image of each block determined through the processing in step S252. Here, the value of C calculated by the above Expression (4) is employed as the suitability, for example.

In step S254, the specified image insertion block determining unit 115 determines a block where the suitability calculated by the processing in step S253 is the highest (e.g., block where the value of C is the smallest) to be a block into which the specified image should be inserted.

In step S255, the image replacing unit 116 replaces, with the photomosaic image stored in the photomosaic image storage memory 118, the image of the block determined by the specified image insertion block determining unit 115 with the specified image. Thus, the specified image inserting processing is executed.

With the example descried above with reference to FIG. 20, the user specifies a region into which the specified image should be inserted, but it is further convenient that the specified image can be inserted without such region specification by the user.

For example, in the event that suitability is calculated regarding all of the blocks of the produced target image, and a block having the highest suitability is determined to be a block into which the specified image should be inserted, it is possible to automatically insert the specified image. That is to say, in this case, the user does not have to specify a region.

However, in such a case, for example, the specified image may be inserted into a block positioned on the edge portion of the produced target image. In this case, it is difficult to think that most of the users satisfy the generated photomosaic image.

Accordingly, even in the event of automatically inserting the specified image, it is desirable to consider not only suitability but also a region within the image.

FIG. 24 is a block diagram illustrating another configuration example of the specified image inserting unit 110 of the photomosaic image generating device 10 illustrated in FIG. 20. With the specified image inserting unit 110 illustrated in the drawing, in the same way as with the case of FIG. 21, the user is allowed to use a specified image as a mosaic tile in a predetermined region, but the user does not have to specifically specify a region. That is to say, in the case of the example in FIG. 24, the specified image inserting unit 110 automatically inserts a specified image, and at this time, a region within the image is taken into consideration.

The specified image inserting unit 110 illustrated in FIG. 24 is configured so as to include a suitability calculating unit 124, a weighting unit 125, an image replacing unit 126, a produced target image storage memory 127, and a photomosaic image storage memory 128.

The produced target image supplied from the photomosaic image generating unit 30 is stored in the produced target image storage memory 127. Also, the photomosaic image supplied from the photomosaic image generating unit 30 is stored in the photomosaic image storage memory 128.

The suitability calculating unit 124 calculates, in the same way as with the specified image insertion block determining unit 115 in FIG. 21, suitability as to the specified image regarding the image of each block of the produced target image for each block. The suitability calculating unit 124 calculates suitability regarding the image of each of all the blocks of the produced target image, for example. For example, the value of C calculated by the above Expression (4) is employed as the suitability.

Now, let us say that the data of the specified image has been supplied to the specified image inserting unit 110.

Subsequently, the suitability calculating unit 124 supplies the calculated suitability to the weighting unit 125 in a manner correlated with information for determining the position of a block. That is to say, the weighting unit 125 is configured so as to determine which block of the produced target image the supplied suitability corresponds to.

The weighting unit 125 performs weighting as to the suitability supplied from the suitability calculating unit 124 according to the position of the block correlated with the suitability thereof. The weighting unit 125 calculates, for example, distance between the position of the block most suitable for inserting the specified image, and the position of the block correlated with the suitability, and performs weighting such that the greater the distance is, the lower the suitability is.

For example, the block most suitable for inserting the specified image will be determined to be a block positioned at the center (the center of gravity) of the produced target image. In this case, even if the suitability calculated by the suitability calculating unit 124 is the same, the suitability of the block distant from the center is low (e.g., the value of C increases), and the suitability of the block close to the center is high (e.g., the value of C decreases).

As described above, the weighting table for performing weighting according to the position of the block is stored in the weighting unit 125. As for the weighting table, the table generated beforehand may be employed, for example, based on the number of blocks and the number of pixels of the produced target image, or the user may set the table as appropriate.

Note that the block most suitable for inserting the specified image may be a block positioned other than the center (the center of gravity) of the produced target image. For example, the block most suitable for inserting the specified image may be a block where the summation of the luminance values of pixels within the produced target image. Alternatively, the block most suitable for inserting the specified image may be a block of a region making up the feature portion (e.g., eye, mouth, etc.) determined by the feature region detecting unit 21.

Further, one block may be determined as the block most suitable for inserting the specified image, or each of multiple different blocks may be determined as the block most suitable for inserting the specified image.

The image replacing unit 126 determines a block into which the specified image should be inserted based on the suitability subjected to weighting as a result of the processing of the weighting unit 125. At this time, for example, a block having the highest suitability (e.g., the value of C subjected to weighting is the smallest) is determined to be a block into which the specified image should be inserted. Subsequently, the image replacing unit 126 replaces, with the photomosaic image stored in the photomosaic image storage memory 128, the image of the determined block with the specified image.

Subsequently, the photomosaic image after replacement by the image replacing unit 126 is output from the photomosaic image generating device 10 as an output image.

Thus, even in the event of automatically inserting the specified image, not only the specified image is simply inserted while considering suitability but also a region within the image may be taken into consideration.

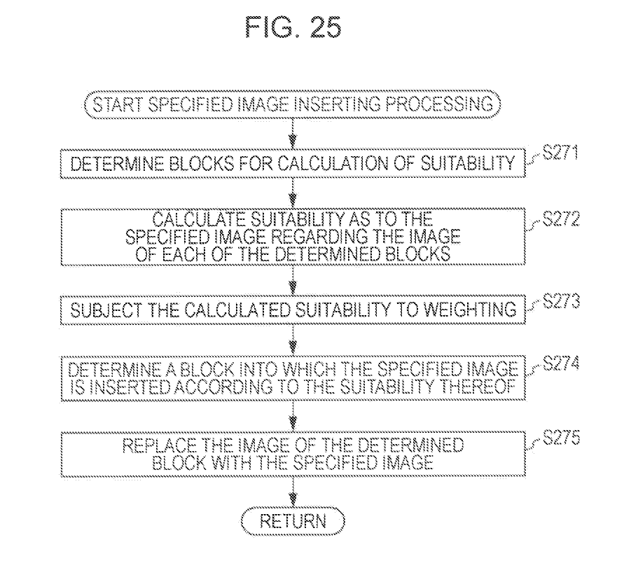

Next, description will be made regarding a detailed example of specified image inserting processing to be executed by the specified image inserting unit 110 illustrated in FIG. 24, with reference to the flowchart in FIG. 25. This processing is executed as the processing in step S223 in FIG. 22.

In step S271, the suitability calculating unit 124 determines the block of the produced target image for calculating suitability. At this time, all of the blocks of the produced target image may be determined to be a block for calculating suitability, or the block of a position set beforehand may be determined to be a block for calculating suitability.

In step S272, the suitability calculating unit 124 calculates suitability as to the specified image regarding the image of each block determined in the processing in step S271. For example, the value of C calculated by the above Expression (4) is used as the suitability.

Also, the suitability calculating unit 124 supplies the calculated suitability to the weighting unit 125 in a manner correlated with information for determining the position of the block.

In step S273, the weighting unit 125 performs weighting as to the suitability supplied from the suitability calculating unit 124 according to the position of the block correlated with the suitability thereof. At this time, for example, distance between the position of the block most suitable for inserting the specified image, and the position of the block correlated with the suitability is calculated, and weighting according to the distance thereof is performed with reference to the weighting table.

In step S274, the image replacing unit 126 determines a block into which the specified image should be inserted based on the suitability subjected to weighting as a result of the processing in step S273. At this time, for example, a block having the highest suitability is determined to be a block into which the specified image should be inserted.

In step S275, the image replacing unit 126 replaces, with the photomosaic image stored in the photomosaic image storage memory 128, the image of the block determined in the processing in step S274 with the specified image. Thus, the specified image is inserted into a predetermined block. Thus, the specified image inserting processing is executed.

Such as described above with reference to FIGS. 20 through 25, according to an embodiment of the present invention, the user is allowed to use the specified image in a predetermined region as a mosaic tile.

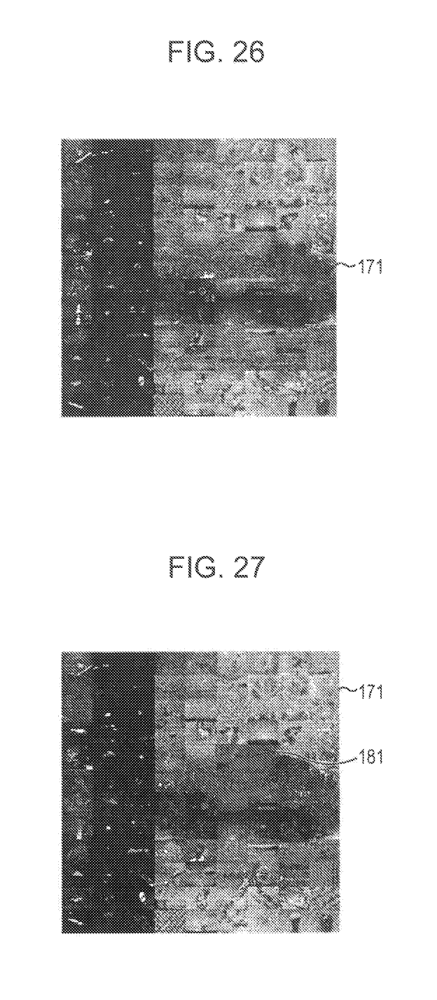

FIG. 26 is a diagram illustrating an example of the photomosaic image generated by the photomosaic image generating unit 30. In this drawing, a photomosaic image 171 is illustrated.

FIG. 27 is a diagram illustrating an example of a photomosaic image obtained by subjecting the photomosaic image 171 in FIG. 26 to the processing of the specified image inserting unit 110 in FIG. 20. In this drawing, the image of a block 181 within the photomosaic image 171 has been replaced with the specified image.

Description has been made so far regarding a case where the number of the specified images is one as an example, but it goes without saying that multiple specified images may be inserted. In the event that there are multiple specified images, for example, it is also possible to specify a region into which the specified image should be inserted for each of the specified images.

Also, in the event that there are multiple specified images, for example, it is desirable to prevent the specified images to be redundantly pasted within a predetermined range, for example, by setting a block on which the specified image is pasted to a flag. For example, in the event that a block into which one specified image should be inserted has been determined, a flag representing that the specified image has been inserted regarding the block thereof is set. Subsequently, a block into which another specified image should be inserted is determined out of blocks other than a block positioned within a predetermined range around the block to which the flag is set.

Also, description has been made so far on the premise that the specified image is an image not included in the image database 51, but an image included in the image database 51 may be the specified image. In this case, for example, an arrangement may be made wherein the specified image inserting unit 110 determines whether or not the specified image is included in the photomosaic image generated by the photomosaic image generating unit 30. Subsequently, only in the event that determination is made that no specified image is included, the specified image inserting unit 110 executes the specified image inserting processing described above with reference to FIG. 23 or 25.

Alternatively, multiple image databases may be provided. For example, an arrangement may be made wherein an image database A and an image database B are provided, and let us say that the image database A is a database made up of images that the user intends to employ as a photomosaic image, and the database B is a database made up of usual images. Subsequently, when attempting to generate a photomosaic image using only an image of the image database A, only the image of a block from which a suitable image has not been obtained is replaced with an image of the image database B.

In this case, for example, first, the photomosaic image generating unit 30 uses only the image database A to generate a photomosaic image. At this time, the photomosaic image generating unit 30 prevents the image of a block where an image of which the suitability is equal to or greater than a threshold is not included in the image database A, from being replaced, and a flag for determining such a block, or the like is set.

Subsequently, the photomosaic image generating unit 30 takes only a block to which a flag is set (block of which the image has not been replaced) as an object, and performs generation of a photomosaic image again using the image database B alone.

Note that in this case, the specified image inserting unit 110 does not have to be provided.

Thus, a photomosaic image where the user's desired image is employed as much as possible can be generated.

Description has been made so far regarding a case where first a photomosaic image is generated, and then the specified image is inserted, but the processing does not have to be performed in such a sequence. For example, an arrangement may be made wherein after the produced target image is divided into blocks, the image of a predetermined block is replaced with the specified image by the specified image inserting unit 110, and then the image of another block is replaced with an image of the image database 51 by the photomosaic image generating unit 30.

Also, description has been made so far regarding an example wherein the photomosaic image generating device 10 is configured of the produced target image processing unit 20, photomosaic image generating unit 30, and specified image inserting unit 110, but other configurations may be employed.

For example, a device which realizes the function of the specified image inserting unit 110 may be connected to a photomosaic image generating device according to the related art.

Even in the event that the specified image inserting unit 110 is used standalone, as described above, for example, the user is allowed to use the specified image in a predetermined region as a mosaic tile. Accordingly, an advantage can be expected wherein a photomosaic image can be generated without a special device or skill.

Incidentally, with the above example, description has been made wherein an image stored in the image database 51 may be subjected to filter processing for removing blurring or the like, and then stored in the cumulative memory 38 in a manner correlated with the corresponding classified class.

However, some images stored in the image database 51 includes noise. In the event that the amount of noise components within an image is extremely great, even if the noise is corrected, artifacts (traces of correction processing which catches an observer's eye, etc.) often remain. If the image including such an artifact is used as a mosaic tile, there is a high possibility that an unnatural photomosaic image will be generated.

Similarly, in the event that a degree of blurring is extremely great as well, even if the blurring is removed by filter processing, an artifact remains.

Further, for example, in the event that a frame is added to an image, if the image thereof is used as a mosaic tile, there is a high possibility that an unnatural photomosaic image will be generated.

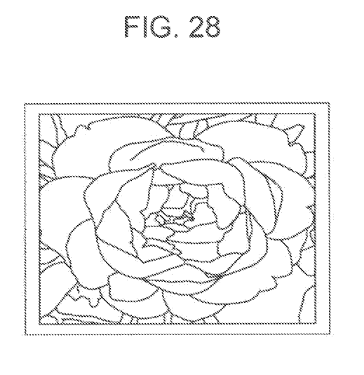

FIG. 28 is a diagram illustrating an example of an image to which a frame is added. In this drawing, a white frame is added to the four sides of an image with a flower as a subject.

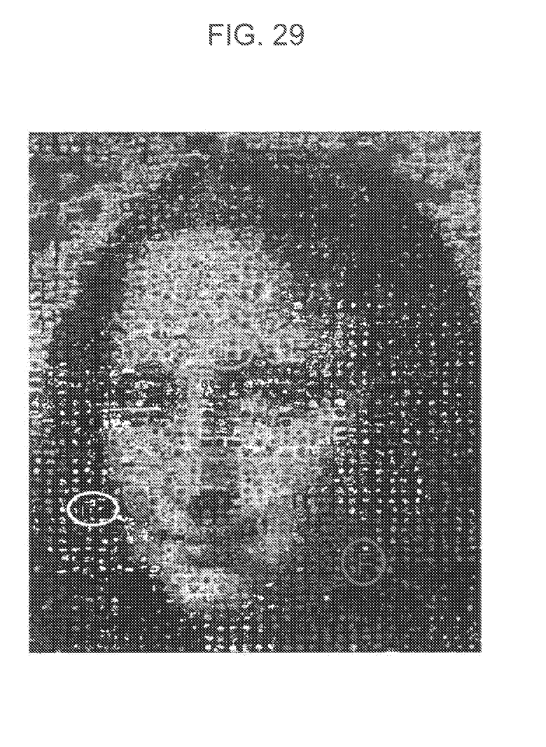

FIG. 29 is a diagram illustrating an example of a photomosaic image generated using an unsuitable image serving as a mosaic tile. In this drawing, with a region indicated with an ellipse, an image to which a frame is added is used as a mosaic tile, and accordingly, this image is a photomosaic image giving an unnatural impression when observed as a whole.

Therefore, with an embodiment of the present invention, an image including noise, a blurred image, and an image to which a frame is added will not be employed as a mosaic tile.

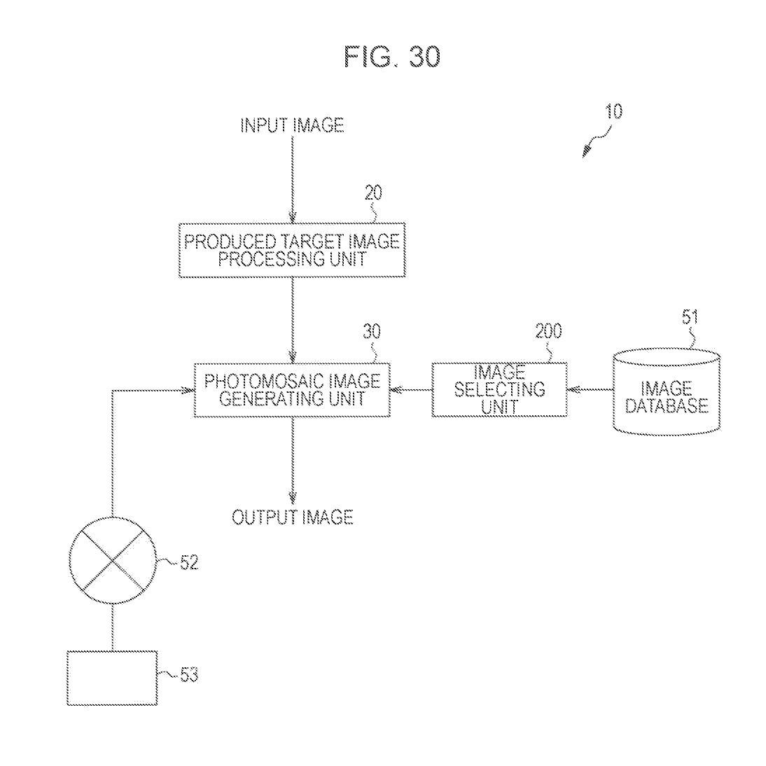

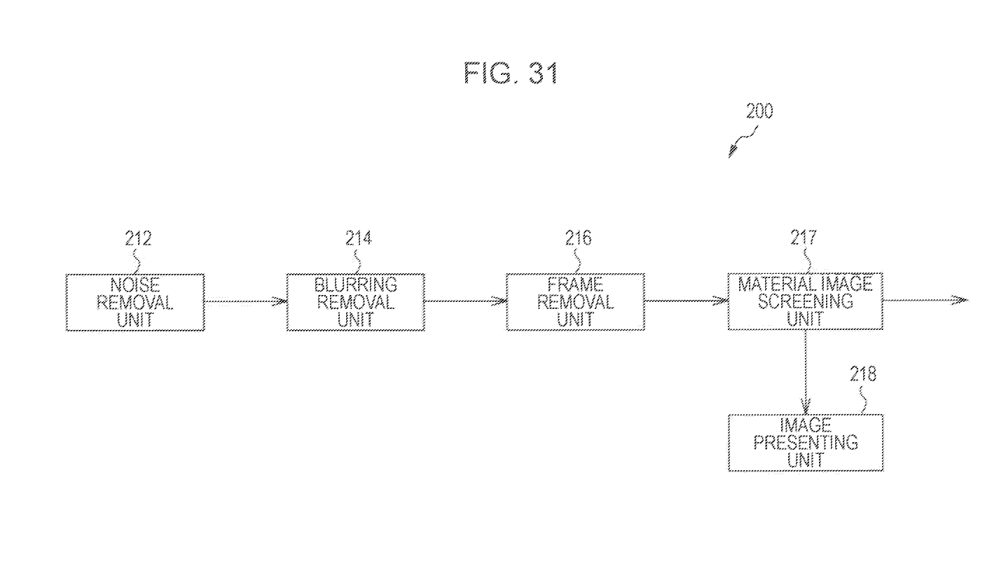

FIG. 30 is a block diagram illustrating yet another configuration example of a photomosaic image generating device according to an embodiment of the present invention. With the photomosaic image generating device 10 illustrated in this drawing, an image including noise, a blurred image, and an image to which a frame is added can be prevented from being employed as a mosaic tile.

FIG. 30 is a diagram corresponding to FIG. 1, wherein the function block corresponding to each portion in FIG. 1 is denoted with the same reference numeral. With the example in FIG. 30, unlike the case of FIG. 1, an image selecting unit 200 is provided. The configurations of other portions in FIG. 30 are the same as with the case of FIG. 1, and accordingly, detailed description thereof will be omitted.

The image selecting unit 200 is configured to perform correction or screening or the like of an image unsuitable for an image (material image) serving as a mosaic tile.

The image selecting unit 200 is configured to detect, from the images stored in the image database 51, images including noise, blurred images, and images to which a frame has been added. Now, in this case, for example, let us say that the user checks the images of the image database 51 beforehand, and extracts an image including noise, a blurred image, and an image to which a frame is added. Subsequently, the user sets the extracted images to a flag or the like representing an image including noise, a blurred image, and an image to which a frame is added, and then stores in the image database 51 again. The image selecting unit 200 detects an image including noise, a blurred image, and an image to which a frame is added, for example, based on the flags added to the images.

Also, the image selecting unit 200 is configured to perform correction of an image detected such as described above. The image selecting unit 200 performs, for example, correction for removing noise from an image including noise, correction for removing blurring from a blurred image, and correction for removing a frame from an image to which a frame is added.

Further, the image selecting unit 200 determines an image including noise, a blurred image, and an image to which a frame is added to be an image unsuitable for a material image, and can prevent these images from being supplied to the photomosaic image generating unit 30.

FIG. 31 is a block diagram illustrating a detailed configuration example of the image selecting unit 200. Such as illustrated in this drawing, the image selecting unit 200 is configured so as to include a noise removal unit 212, a blurring removal 214, a frame removal unit 216, a material image screening unit 217, and an image presenting unit 218.

The noise removal unit 212 is configured of a £ filter or the like, for example. The noise removal unit 214 detects an image to which a flag representing that this image includes noise, and subjects the image thereof to filter processing for adjusting the threshold of the ε filter for each pixel, and removing noise components from the input signal, for example.

The blurring removal unit 214 is configured as a filter or the like for subjecting the blurred image to arithmetic processing by an inverse function of a model expression representing a relation between the pixels of a blurred image and the pixels of an unblurred image, for example. The blurring removal unit 214 detects an image to which a flag representing that this image is a blurred image, and subjects the image thereof to filter processing for removing blurring from the image thereof, for example.

Note that a shaking removal unit having a common shaking correction function may be provided along with the blurring removal unit 214.

The frame removal unit 216 is configured to remove the frame of an image by the following processing, for example. The frame removal unit 216 detects difference between adjacent pixel values within an image, and determines a pixel where the difference between adjacent pixel values is equal to or greater than a threshold to be a pixel candidate making up a frame. Subsequently, in the event that a predetermined number or more of pixels having the same (or within a certain range) pixel value as the pixel value serving as the candidate thereof, exist consecutively in the horizontal or vertical direction, the pixels of the consecutively existing portion thereof are detected as pixels making a frame.

Specifically, the frame removal unit 216 detects an extremely bright color, or dark-colored strip-shaped object in the horizontal or vertical direction made up of generally the same pixel value within the image as a frame. In such a case, for example, a part of a building, wall paper of a room, and so forth, which were taken as the background of a subject, may also be erroneously detected as a frame. However, even if such an object is not a frame, a photomosaic image with an image including such an strip-shaped object as a material image often gives an unnatural impression to an observer, and accordingly, we can say that such an image is unsuitable for a material image.

The frame removal unit 216 detects an image to which a flag representing that this image is an image to which a frame is added, and removes the frame by replacing the value of a pixel of the frame (strip-shaped object) detected such as described above with the value of a pixel adjacent to the frame, for example.

Alternatively, a frame may be removed, for example, by removing the pixels of the edge portion of the four sides of an image to which a flag representing that this image is an image to which a frame is added, in certain width, and enlarging the image made up of the remaining pixels to the size of the original image.

The material image screening unit 217 outputs the image obtained through the processing of the noise removal unit 212, blurring removal unit 214, and frame removal unit 216 to the image presenting unit 218. The image presenting unit 218 outputs the image supplied from the material image screening unit 217 on the display, thereby presenting this to the user, and accepts the user's evaluation. For example, the image presenting unit 218 accepts an evaluation representing that the display image is suitable or unsuitable for a material image, from the user.

The user observes the image, and can evaluate as unsuitable regarding an image in which an artifact remains even after correction for removing noise or the like, for example. On the other hand, as for an image from which noise or the like is suitably removed by correction, the user can evaluate as suitable.

The material image screening unit 217 is configured to supply only an image evaluated as suitable of the images output to the image presenting unit 218 to the photomosaic image generating unit 30.

Also, the material image screening unit 217 may not supply all of the images to which a flag representing that the image is an image to which a frame is added is set, to the photomosaic image generating unit 30.

Thus, an image including noise, a blurred image, and an image to which a frame is added can be prevented from being employed as a mosaic tile.

Note that, as described above, for example, noise or the like can be removed by correction, and an image in which an artifact remains even after such correction can also be prevented from being employed as a mosaic tile. Accordingly, more accurately, an image which the user feels to be visually strange, can be prevented from being employed as a mosaic tile.

Next, description will be made regarding an example of the photomosaic image generating processing to be executed by the photomosaic image generating device 10 illustrated in FIG. 30, with reference to the flowchart illustrated in FIG. 30.

The processing in step S301 is the same as step S21 in FIG. 6, and accordingly, detailed description thereof will be omitted.

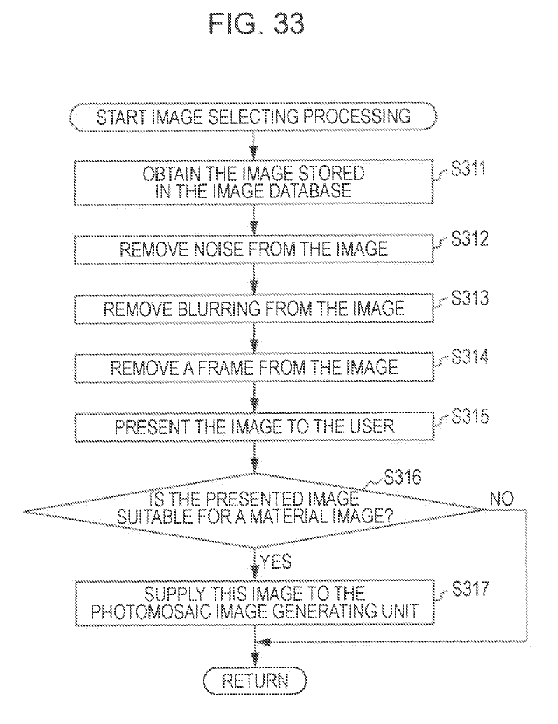

In step S302, the image selecting unit 200 executes image selecting processing described later with reference to FIG. 33. Thus, only an image suitable for a material image is supplied to the photomosaic image generating unit 30.

The processing in step S303 is the same as step S22 in FIG. 6, and accordingly, detailed description thereof will be omitted.

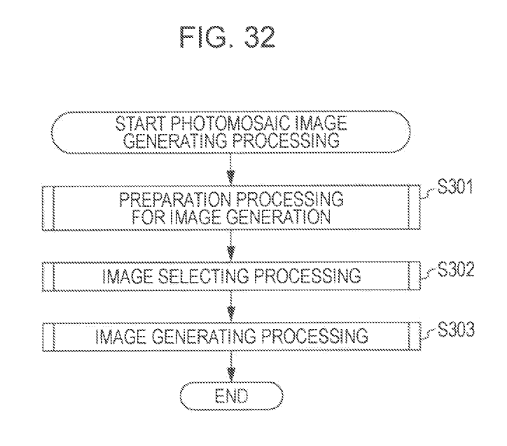

Next, a detailed example of the image selecting processing in step S302 in FIG. 32 will be described with reference to the flowchart in FIG. 33.

In step S311, the image selecting unit 200 obtains an image stored in the image database 51.

In step S312, the noise removal unit 214 detects, for example, an image to which a flag representing that this image is an image including noise is set, and subjects the image thereof to filter processing for removing noise components from the image.

In step S313, the blurring removal unit 214 detects an image to which a flag representing that this image is a blurred image is set, and subjects the image thereof to filter processing for removing blurring.

In step S314, the frame removal unit 216 detects an image to which a flag representing that this image is an image to which a frame is added is set, and removes the frame by replacing the values of the pixels of the frame (strip-shaped object) with the value of a pixel adjacent to the frame, for example.

In step S315, the material image screening unit 217 outputs the image obtained through the processing in steps S312 through S314 to the image presenting unit 218. At this time, the image presenting unit 218 outputs the image supplied from the material image screening unit 217 on the display, thereby presenting this to the user, and accepts the user's evaluation. For example, the image presenting unit 218 accepts an evaluation representing that the display image is suitable or unsuitable for a material image, from the user.

The user observes the image, and can evaluate as unsuitable regarding an image which the user feels to be visually strange, such that an image in which an artifact remains even after correction for removing noise or the like, for example. On the other hand, as for an image from which noise or the like is suitably removed by correction, the user can evaluate as suitable. The user's evaluation result is added to the image as a flag, for example.

In step S316, the material image screening unit 217 determines whether or not the image presented to the user in the processing in step S315 is an image suitable for a material image.

In the event that determination is made in step S316 that the presented image is an image suitable for a material image, the processing proceeds to step S317.

In step S317, the image selecting unit 200 supplies this image to the photomosaic image generating unit 30.

On the other hand, in the event that determination is made in step S316 that the presented image is an image unsuitable for a material image, the processing in step S317 is skipped.

That is to say, of the images output to the image presenting unit 218, an image evaluated as unsuitable is excluded from the images to be supplied to the photomosaic image generating unit 30, and only an image evaluated as suitable is supplied to the photomosaic image generating unit 30.

Alternatively, in step S316, the material image screening unit 217 may determine all of the images to which a flag representing an image including noise, a blurred image, or an image to which a frame is added is set to be an image unsuitable for a material image. In such a case, the processing in steps S312 through S315 may not be executed. Thus, the image selecting processing is executed.

Description has been made so far regarding an example wherein the photomosaic image generating device 10 is configured of the produced target image processing unit 20, the photomosaic image generating unit 30, and the image selecting unit 200, but other configurations may be employed.

For example, a device which realizes the function of the image selecting unit 200 may be connected to a photomosaic image generating device according to the related art.

As described above, an image including noise, a blurred image, and an image to which a frame is added can be prevented from being employed as a mosaic tile by the image selecting unit 200. Accordingly, even when the image selecting unit 200 is used standalone, for example, an advantage can be expected wherein a beautiful photomosaic image can be generated without special skills or the like.

Incidentally, there has been a problem wherein in the event that an image unsuitable for the produced target image has been input, even when suitably selecting an image to be pasted on each block, the quality of a generated photomosaic image deteriorates. For example, in the event that difference between the pixel values of a subject, and the pixel values of the background within the produced target image is small, when the size of a subject within the produced target image is extremely small, even if an image having sufficiently high suitability is pasted on each block, a highly-attractive photomosaic image is not generated.

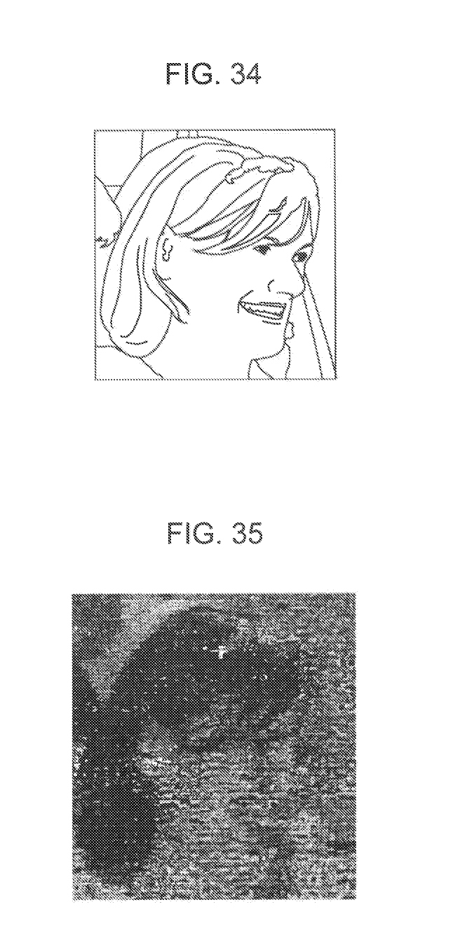

FIG. 34 is a diagram illustrating an example of an image where difference between the pixel values of a subject and the pixel values of the background is small. This drawing is a photo image where a female face is taken as a subject, the color of a pace portion, and the color of the background (wall) are generally the same color principally on the right side in the drawing. That is to say, this drawing is an image where difference between the pixel values of the subject, and the pixel values of the background is small.

FIG. 35 is a diagram illustrating an example of a photomosaic image generated with the image in FIG. 34 as the produced target image. Such as illustrated in the drawing, the female face illustrated in FIG. 34 is not recognized from the generated photomosaic image, and impression is received wherein the outline of the face is unclear particularly at the portion on the right side in the drawing.

Thus, in the event that difference between the pixel values of a subject, and the pixel values of the background within the produced target image is small, even if an image having sufficiently high suitability is pasted on each block, a highly-attractive photomosaic image is not generated.

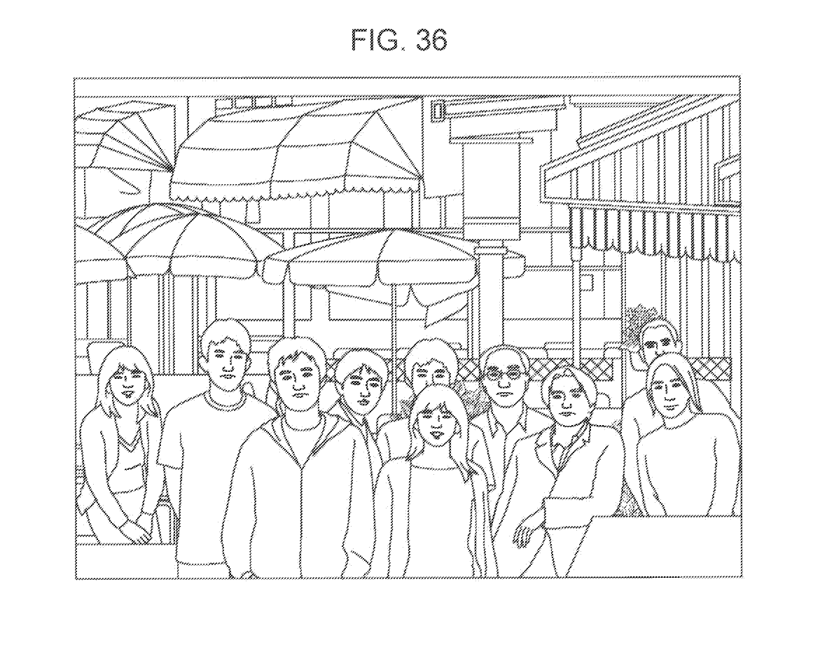

FIG. 36 is a diagram illustrating an example of an image where the size of a subject is extremely small. This drawing is a mass group photo image, wherein an individual person can be recognized, but the region of pixels making up one person is an extremely small region as viewed from the whole image.

With such a photomosaic image generated with an image where the size of a subject is extremely small as the produced target image, the outline of a subject (each of the persons) or the like is apt to be unclear. Accordingly, in the event that the size of a subject within the produced target image is extremely small, even if an image having sufficiently high suitability is pasted on each block, a highly-attractive photomosaic image is not generated.

Therefore, with an embodiment of the present invention, an arrangement is made wherein determination is made beforehand whether or not the input image is an image suitable for the produced target image.

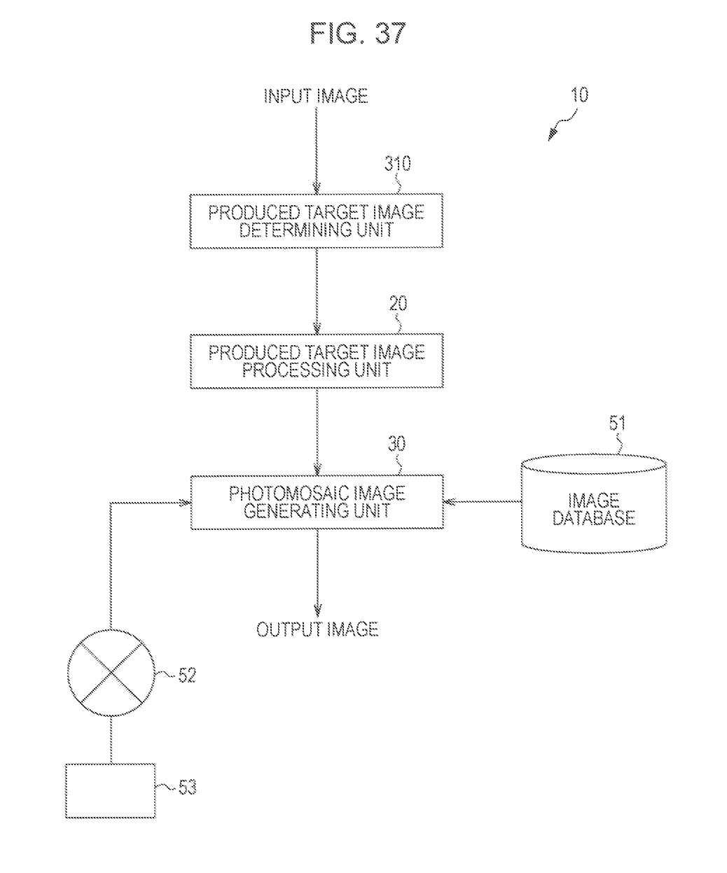

FIG. 37 is a block diagram illustrating a configuration example of the photomosaic image generating device whereby determination is made beforehand whether or not the input image is an image suitable for the produced target image. This drawing is a diagram corresponding to FIG. 1, wherein each portion corresponding to FIG. 1 is denoted with the same reference numeral. With the example in FIG. 37, unlike the case of FIG. 1, a produced target image determining unit 310 is provided.

The produced target image determining unit 310 determines whether or not the input image is an image suitable for the produced target image, and for example, outputs only the input image determined to be suitable to the produced target image processing unit 20. Alternatively, the determination result regarding whether or not the input image is an image suitable for the produced target image may be presented to the user.

Other configurations in FIG. 37 are the same as with the case of FIG. 1, and accordingly, detailed description thereof will be omitted.

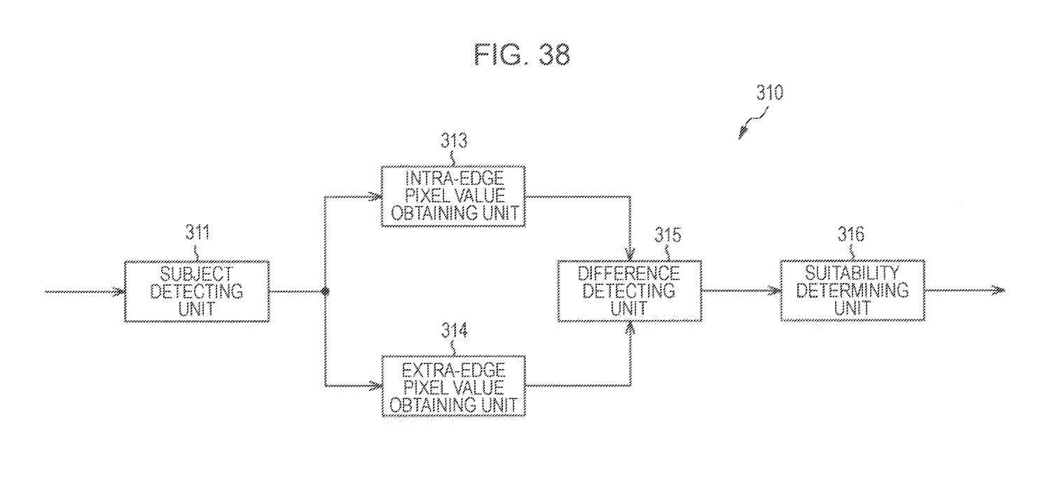

FIG. 38 is a block diagram illustrating a detailed configuration example of the produced target image determining unit 310 in FIG. 37. In the event that the input image is an image where difference between the pixel values of a subject and the pixel values of the background is small, this produced target image determining unit 310 determines the input image to be an image unsuitable for the produced target image.

With the example of this drawing, the produced target image determining unit 310 is configured of a subject detecting unit 311, an intra-edge pixel value obtaining unit 313, an extra-edge pixel value obtaining unit 314, a difference detecting unit 315, and a suitability determining unit 316.

The subject detecting unit 311 is configured to perform analysis of the input image to detect a subject within the image. The subject detecting unit 311 detects, for example, a person's image within the image. Detection of a person's image is performed based on, for example, the feature amount of the image, model data stored beforehand, and so forth.

The subject detecting unit 311 determines each of pixels making up the detected subject, for example, by coordinate values. Thus, the pixels of the image of a subject, and the pixels of an image other than the subject (e.g., background) within the input image can be determined.

The intra-edge pixel value obtaining unit 313 determines, based on the detection result of the subject detecting unit 311, a boundary (edge) between the image of a subject, and the image other than the subject, and obtains the values of pixels of the image of the subject adjacent to the pixels of the image other than the subject.

The extra-edge pixel value obtaining unit 314 determines, based on the detection result of the subject detecting unit 311, a boundary (edge) between the image of a subject, and the image other than the subject, and obtains the values of pixels of the image other than the subject adjacent to the pixels of the image of the subject.

Each of the intra-edge pixel value obtaining unit 313 and the extra-edge pixel value obtaining unit 314 gradually obtains pixel values along the border line of a subject, for example. Subsequently, pairs of pixels obtained by the intra-edge pixel value obtaining unit 313 and the extra-edge pixel value obtaining unit 314 is supplied to the difference detecting unit 315, respectively.

Now, in order to simplify description, let us say that with one point on the border line of a subject, a pair made up of the value of one pixel of the edge of the subject, and the value of one pixel of the background or the like adjacent to that pixel is obtained. However, for example, an arrangement may be made wherein with one point on the border line of a subject, the pixel values of multiple pixels set beforehand around the edge are obtained by the intra-edge pixel value obtaining unit 313 and the extra-edge pixel value obtaining unit 314 respectively, and pairs of these pixel values are supplied to the difference detecting unit 315, respectively. Alternatively, an arrangement may be made wherein the mean value of the pixel values of the multiple pixels is each obtained, and a pair of the mean values is supplied to the difference detecting unit 315.

Further, how many pixels worth of values around the edge are obtained may be set beforehand, or may be specified by the user as appropriate, or may be determined according to the number of pixels making up the image of a subject.

Also, the intra-edge pixel value obtaining unit 313 and the extra-edge pixel value obtaining unit 314 does not have to obtain the above pairs at all of the points on the border line of the subject respectively, and for example, may obtain the above pairs at a portion set beforehand, or a portion specified by the user.

The difference detecting unit 315 calculates difference values of the pairs of pixel values supplied from the intra-edge pixel value obtaining unit 313 and the extra-edge pixel value obtaining unit 314 such as described above, respectively. The difference detecting unit 315 compares, for example, the individually calculated difference values with a threshold set beforehand, and determines the ratio of the number of pairs having a difference value equal to or greater than a threshold of the supplied pairs of the pixel values.

The suitability determining unit 316 performs further threshold determination using another threshold as to the ratio determined by the difference detecting unit 315, and in the event that determination is made that the ratio is equal to or greater than the threshold, determines the input image to be suitable for the produced target image. This is because, with such an image, it can be conceived that the difference between the pixel values of the subject and the pixel values of the background is sufficiently great.

On the other hand, in the event that determination is made that the ratio is less than a threshold, the suitability determining unit 316 determines the input image to be unsuitable for a produced target image. This is because it can be conceived that such an image is small in the difference between the pixel values of the subject and the pixel values of the background.

Alternatively, such as described later, the pixel values of an image other than the subject of the input image may be changed. That is to say, the pixel values are corrected so as to obtain an image where the difference between the pixel values of the subject and the pixel values of the background is sufficiently great. Thus, it is possible to change an unsuitable produced target image to a suitable produced target image to output this.

Note that the above difference detecting method by the difference detecting unit 315, and the suitability determining method by the suitability determining unit 316 are an example, and other methods may be employed.

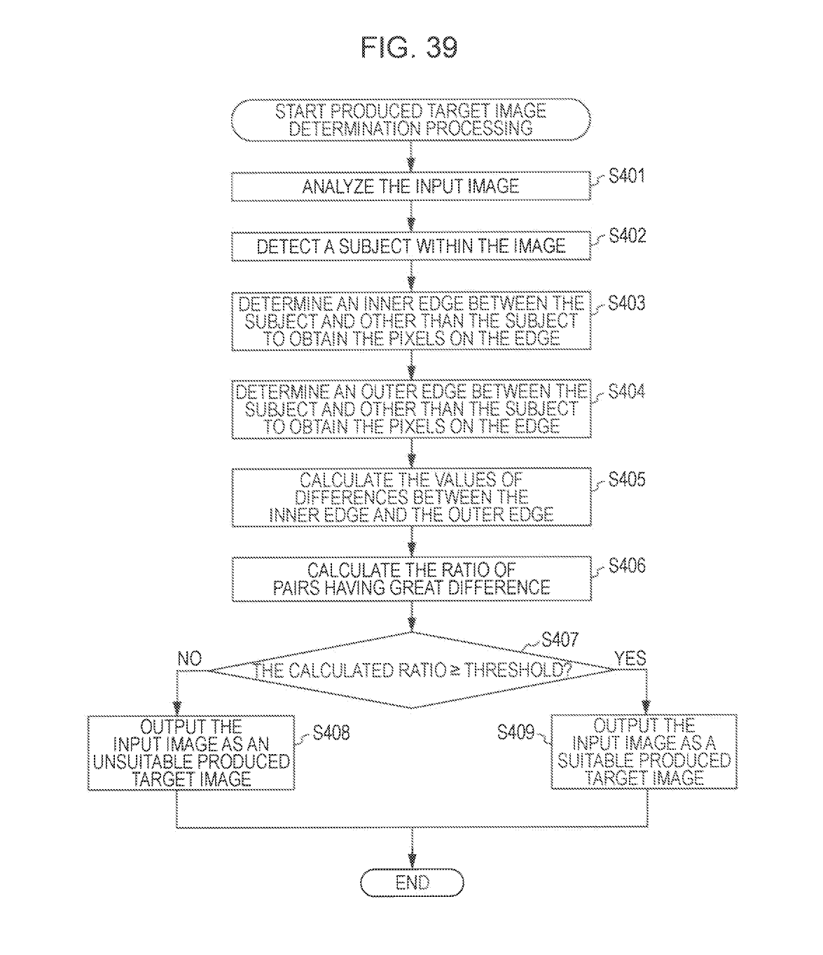

Next, description will be made regarding an example of the produced target image determining processing by the produced target image determining unit 310 in FIG. 38, with reference to the flowchart in FIG. 39.

In step S401, the subject detecting unit 311 analyzes the input image.

In step S402, the subject detecting unit 311 detects a subject within the image. Thus, the pixels of the image of a subject, and the pixels of the image other than the subject (e.g., background) within the input image can be determined.

In step S403, the intra-edge pixel value obtaining unit 313 determines, based on the detection result of the subject detecting unit 311 in step S402, the boundary (edge) between the image of the subject, and the image other than the subject, and obtains the values of the pixels of the image of the subject adjacent to the pixels of the image other than the subject.

In step S404, the extra-edge pixel value obtaining unit 314 determines, based on the detection result of the subject detecting unit 311 in step S402, the boundary (edge) between the image of the subject, and the image other than the subject, and obtains the values of the pixels of the image other than the subject adjacent to the pixels of the image of the subject.

In step S405, the difference detecting unit 315 calculates the value of the difference between the pair of the pixel values obtained and supplied by the intra-edge pixel value obtaining unit 313 and the extra-edge pixel value obtaining unit 314 as results of the processing in steps S403 and S404.

In step S406, the difference detecting unit 315 compares, for example, the difference values individually calculated with a threshold set beforehand, and calculates the ratio of the number of pairs having a difference value equal to or greater than the threshold as to the pairs of the pixel values supplied.

In step S407, the suitability determining unit 316 determines whether or not the ratio calculated in the processing in step S406 is equal to or greater than a threshold.

In the event that determination is made in step S407 that the ratio is equal to or greater than a threshold, the processing proceeds to step S409, where the suitability determining unit 316 outputs the input image as a suitable produced target image.

On the other hand, in the event that determination is made in step S407 that the ratio is less than a threshold, the processing proceeds to step S408, where the suitability determining unit 316 outputs the input image as an unsuitable produced target image. Note that in step S408, the suitability determining unit 316 may discard the input image without outputting the input image.

Also, in the processing in steps S407 and S408, the input image may be output along with a score representing suitability serving as a produced target image. For example, an arrangement may be made wherein multiple input images are output along with scores, and based on the scores thereof, the user selects a produced target image as appropriate. In this way, the produced target image determining processing is executed. Thus, generation of a photomosaic image employing an image unsuitable for a produced target image can be prevented.

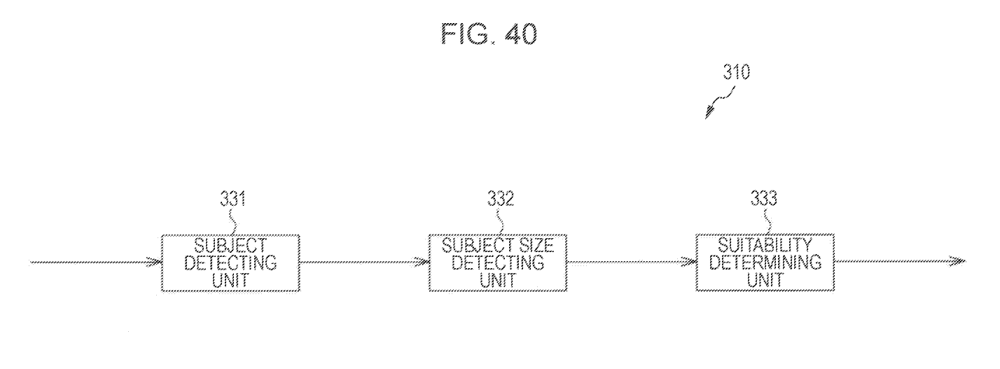

FIG. 40 is a block diagram illustrating another detailed configuration example of the produced target image determining unit 310 in FIG. 37. This produced target image determining unit 310 is configured to determine, when the input image is an image where the size of a subject is extremely small, the input image to be an image unsuitable for a produced target image.

With the example in this drawing, the produced target image determining unit 310 is configured of a subject detecting unit 331, a subject size detecting unit 332, and a suitability determining unit 333.

The subject detecting unit 331 is configured to perform analysis of the input image to detect a subject within the image. The subject detecting unit 331 detects, for example, a person's image within the image. Detection of a person's image is performed based on, for example, the feature amount of the image, model data stored beforehand, and so forth.

The subject detecting unit 331 determines each of pixels making up the detected subject, for example, by coordinate values. Thus, the pixels of the image of a subject, and the pixels of an image other than the subject (e.g., background) within the input image can be determined.

The subject size detecting unit 332 detects the size of the subject based on the detection result of the subject detecting unit 331. Here, the size of the subject is, for example, the number of pixels making up the image of the subject within the input image.

For example, in the event that multiple subjects have been detected by the subject detecting unit 331, the subject size detecting unit 332 may detect the size of each of the subjects, or the mean value of the sizes of these subjects may be detected as the size of the subjects.

The suitability determining unit 333 determines, based on the detection result of the subject size detecting unit 332, whether or not the input image is suitable for a produced target image.

The suitability determining unit 333 calculates, for example, the ratio of the size (e.g., the number of pixels) output from the subject size detecting unit 332 as to the number of all of the pixels of the input image, and determines the ratio thereof with a threshold. Subsequently, in the event that determination is made that the ratio is equal to or greater than the threshold, the suitability determining unit 333 determines the input image to be a suitable image, and in the event that determination is made that the ratio is less than the threshold, determines the input image to be an unsuitable image.

Alternatively, an arrangement may be made wherein based on the size (e.g., the number of pixels) output from the subject size determining unit 332, and the resolution of the input image, a score for evaluating the size of the subject is calculated, and the score thereof is determined with a threshold.

Note that the above size detecting method by the subject size detecting unit 332, and the suitability determining method by the suitability determining unit 333 are an example, and other methods may be employed.

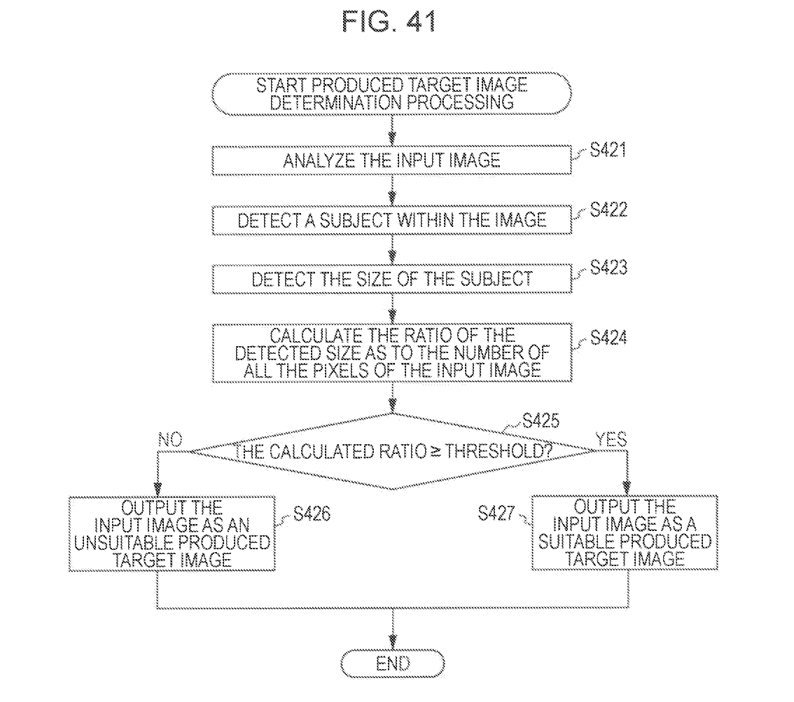

Next, description will be made regarding an example of the produced target image determining processing by the produced target image determining unit 310 in FIG. 40, with reference to the flowchart in FIG. 41.

In step S421, the subject detecting unit 331 analyzes the input image.

In step S422, the subject detecting unit 331 detects a subject within the image. Thus, the pixels of the image of a subject, and the pixels of the image other than the subject (e.g., background) within the input image can be determined.

In step S423, the subject size detecting unit 332 detects, based on the detection result by the processing in step S422, the size of the subject. Here, the size of the subject is, for example, the number of pixels making up the image of the subject within the input image.

In step S424, the suitability determining unit 333 calculates a ratio of the size (e.g., the number of pixels) detected by the processing in step S423 as to the number of all of the pixels of the input image.

In step S425, the suitability determining unit 333 determines whether or not the ratio calculated by the processing in step S424 is equal to or greater than a threshold set beforehand.

In the event that determination is made in step S425 that the ratio is equal to or greater than the threshold, the processing proceeds to step S427, where the suitability determining unit 333 outputs the input image as a suitable produced target image.

On the other hand, in the event that determination is made in step 425 that the ratio is less than the threshold, the processing proceeds to step S426, where the suitability determining unit 333 outputs the input image as an unsuitable produced target image. Note that in step S426, the suitability determining unit 333 may discard the input image without outputting the input image.

Also, in the processing in steps S426 and S427, the input image may be output along with a score representing suitability serving as a produced target image. For example, an arrangement may be made wherein multiple input images are output along with scores, and based on the scores thereof, the user selects a produced target image as appropriate. In this way, the produced target image determining processing is executed. Thus, generation of a photomosaic image employing an image unsuitable for a produced target image can be prevented.

Note that an example illustrated in FIG. 38, and an example illustrated in FIG. 40 have been described as a configuration example of the produced target image determining unit 310, but it goes without saying that the configuration illustrated in FIG. 38 and the configuration illustrated in FIG. 40 may be applied in combination.

Specifically, the produced target image determining unit 310 may be configured wherein an image where difference between the pixel values of a subject and the pixel values of the background is small, or an image where the size of a subject is extremely small is determined to be unsuitable for a produced target image. Further, the produced target image determining unit 310 may be configured wherein an image where difference between the pixel values of a subject and the pixel values of the background is small, which is also an image where the size of a subject is extremely small is determined to be unsuitable for a produced target image.

Incidentally, description has been made wherein with the configuration described above with reference to FIG. 38, and the processing described above with reference to FIG. 39, in the event that determination is made that the ratio of the pairs having great difference is less than a threshold, the input image is determined to be unsuitable for a produced target image. This is because it can be conceived that with such an image, difference between the pixel values of a subject and the pixel values of the background is small.

However, in the event that determination is made that the input image is unsuitable for a produced target image, the pixel values of an image other than a subject may be changed. Specifically, the pixel values are corrected so as to obtain an image where difference between the pixel values of a subject and the pixel values of the background is sufficiently great. Thus, an unsuitable produced target image may be output by being changed to a suitable produced target image.

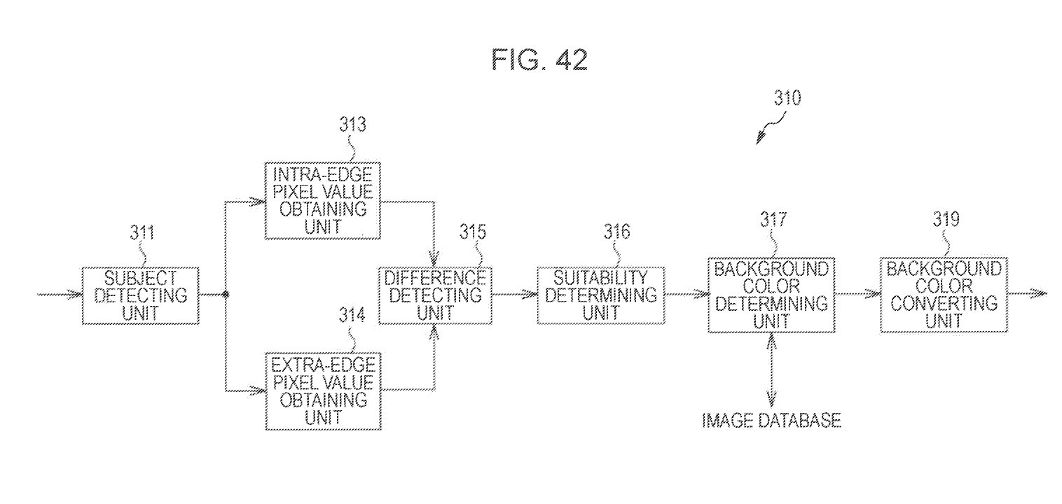

FIG. 42 is a block diagram illustrating a detailed configuration example of the produced target image determining unit 310 wherein in the event that determination is made that the input image is unsuitable for a produced target image, the pixel values of an image other than a subject (e.g., background) of the input image are changed.

This drawing is a diagram corresponding to FIG. 38, wherein each portion corresponding to FIG. 38 is denoted with the same reference numeral.

The subject detecting unit 311 through the suitability determining unit 316 in FIG. 42 are the same as with the case of FIG. 38, and accordingly, detailed description thereof will be omitted. In the case of the configuration in FIG. 42, unlike the case of FIG. 38, a background color determining unit 317 and a background color converting unit 319 are provided.

The input image determined to be unsuitable for a produced target image by the suitability determining unit 316 in FIG. 42 is supplied to the background color determining unit 317.

The background color determining unit 317 calculates, for example, the mean value of the pixel values obtained by the intra-edge pixel value obtaining unit 313, and selects multiple candidates of a color (pixel value) wherein difference with the calculated mean value is sufficiently great. Here, an example of the color candidates is a color wherein regarding a pair between the mean value of the pixel values obtained by the intra-edge pixel value obtaining unit 313 and the pixel value of a color serving as a candidate, the difference calculated by the difference detecting unit 315 is equal to or greater than a threshold set beforehand.

For example, in the event that a pixel value is represented with a three-dimensional vector of RGB, a pixel value of which the Euclidean distance from the mean value of the pixel values obtained by the intra-edge pixel value obtaining unit 313 is equal to or greater than a predetermined value is selected as the pixel value of a color serving as a candidate. For example, a pixel value corresponding to a coordinate position distant by predetermined distance in each direction of R, G, and B from the coordinate position within the three-dimensional space of the mean value of the pixels obtained by the intra-edge pixel value obtaining unit 313, is selected as a color serving as a candidate.

Note that when selecting a color candidate, for example, information relating to the input image may be referenced. For example, an arrangement may be made wherein code or the like representing the type of the input image is input along with the input image, and in the event that code representing an image of a festive occasion has been detected, a color close to black is selected as a candidate. Thus, an arrangement may be made wherein when selecting a color candidate, information relating to the input image is referenced, restrictions are put so as not to select a color unsuitable for a candidate, or a color suitable for a candidate is proactively selected.

Also, the background color determining unit 317 is connected to the image database 51, and compares the mean value of the representing value of each image of the image database 51, and the color of the selected candidate. Subsequently, the background color determining unit 317 determines a candidate color wherein the Euclidean distance with the mean value of the representing value of each image of the image database 51 is less than a predetermined value, as the color of the background. For example, each candidate color, and the representing value of each image (all or a part) within the image database are compared, the number of images within the image database where the distance is close as to each candidate color (distance is equal to or less than a threshold) is calculated, and a candidate color having the most numerous images is determined to be a background color. Thus, after converting the background color, room for selection of an image to be pasted on the block of the background thereof increases. Consequently, there are many images corresponding to the selected background color within the image database 51.

Note that, when determining a background color, for example, a background color may be determined without selecting a candidate color so as to uniformly convert pixel values determined as the pixels of an image other than a subject (e.g., background). For example, in the event of expressing the pixel values of a background image using a three-dimensional vector of RGB, a background color may be determined by increasing or decreasing each of the values of the three factors of each pixel value by a predetermined value.

The background color converting unit 319 converts the value of a pixel determined as a pixel of an image other than a subject (e.g., background) as a result of the processing of the subject detecting unit 311 into a pixel value corresponding to the background color determined by the background color determining unit 317.

Thus, the pixel values are corrected so that the input image becomes an image where difference between the pixel values of a subject and the pixel values of the background is sufficiently great, and accordingly, an unsuitable produced target image can be output by being converted into a suitable produced target image.

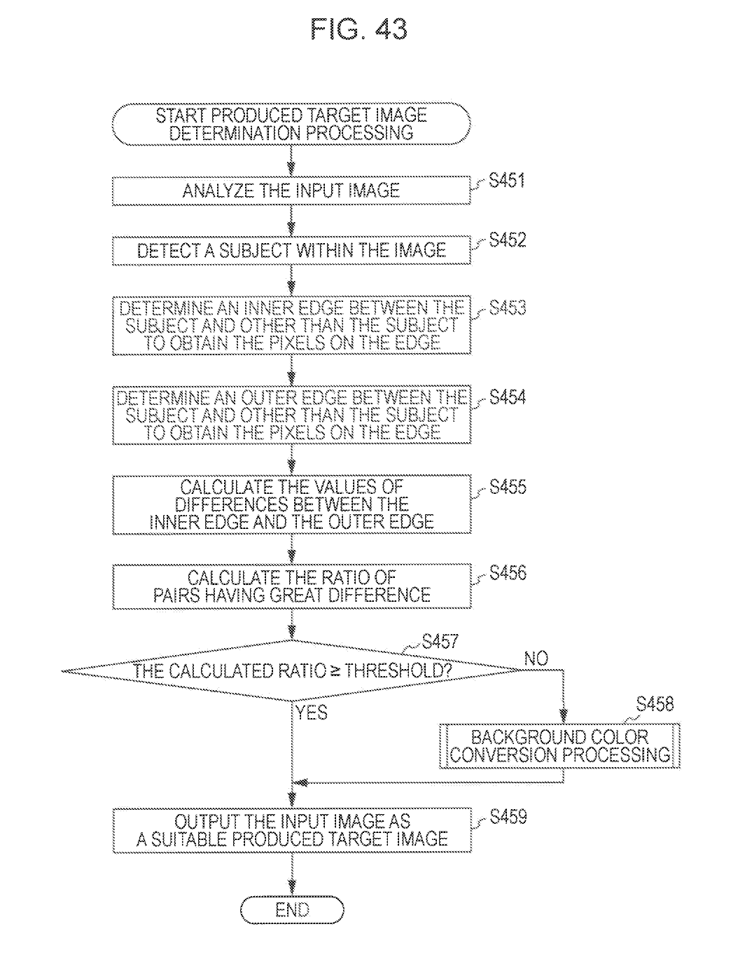

FIG. 43 is a flowchart for describing an example of produced target image determining processing corresponding to the configuration in FIG. 42.

The processing in steps S451 through S457 in FIG. 43 is the same processing as the processing in steps S401 through S407 in FIG. 39, and accordingly, detailed description thereof will be omitted.

In the event that determination is made in step S457 that the ratio calculated in the processing in step S456 is less than a threshold, the processing proceeds to step S458. On the other hand, in the event that determination is made in step S457 that the ratio calculated in the processing in step S456 is equal to or greater than a threshold, the processing in step S458 is skipped.

In step S458, the background color determining unit 317 and the background color converting unit 319 execute background color conversion processing.

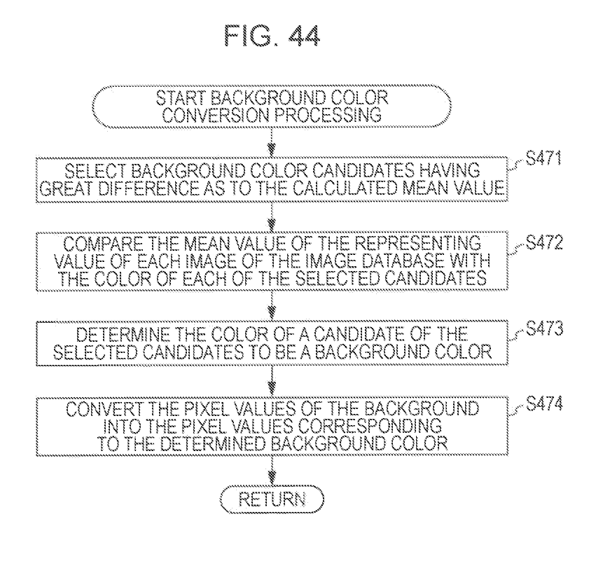

Now, description will be made regarding a detailed example of the background color conversion processing in step S458 in FIG. 43, with reference to the flowchart in FIG. 44.

In step S471, the background color determining unit 317 calculates, for example, the mean value of the pixel values obtained by the intra-edge pixel value obtaining unit 313, and selects multiple candidates of a color (pixel value) wherein difference with the calculated mean value is sufficiently great.

In step S472, the background color determining unit 317 checks the image database 51. At this time, the mean value of the representing value of each image of the image database 51, and the selected candidate color are compared.

In step S473, the background color determining unit 317 determines, for example, of the candidates selected in the processing in step S471, a candidate color wherein the Euclidean distance with the mean value of the representing value of each image of the image database 51 is less than a predetermined value to be a background color.

In step S474, regarding the pixels determined to be the pixels of an image other than the subject as a result of the processing in step S452 in FIG. 43, the background color converting unit 319 converts the values of these pixels (the pixels of an image other than the subject) into a pixel value corresponding to the background color determined in the processing in step S473. Thus, the background color conversion processing is executed.

The processing returns to FIG. 43, where after the processing in step S458, in the event that determination is made in step S457 that the ratio calculated in the processing in step S456 is equal to or greater than a threshold, the processing proceeds to step S459.

In step S459, the input image is output from the produced target image determining unit 310 as a suitable produced target image. In this way, the produced target image determining processing is executed. Thus, an unsuitable produced target image can be output by being converted into a suitable produced target image.

Description has been made so far regarding an example wherein the photomosaic image generating device 10 is configured of the produced target image processing unit 20, photomosaic image generating unit 30, and produced target image determining unit 310, but other configurations may be employed.

For example, a device which realizes the functions of the produced image processing unit 20, and the photomosaic image generating unit 30 may be connected to the photomosaic image generating device according to the related art.

As described above, generation of a photomosaic image employing an image unsuitable for a produced target image by the produced target image determining unit 310 can be prevented. Accordingly, even when the produced target image determining unit 310 is used standalone, an advantage can be expected wherein a beautiful photomosaic image can be generated in a small amount of time without special skills and the like.

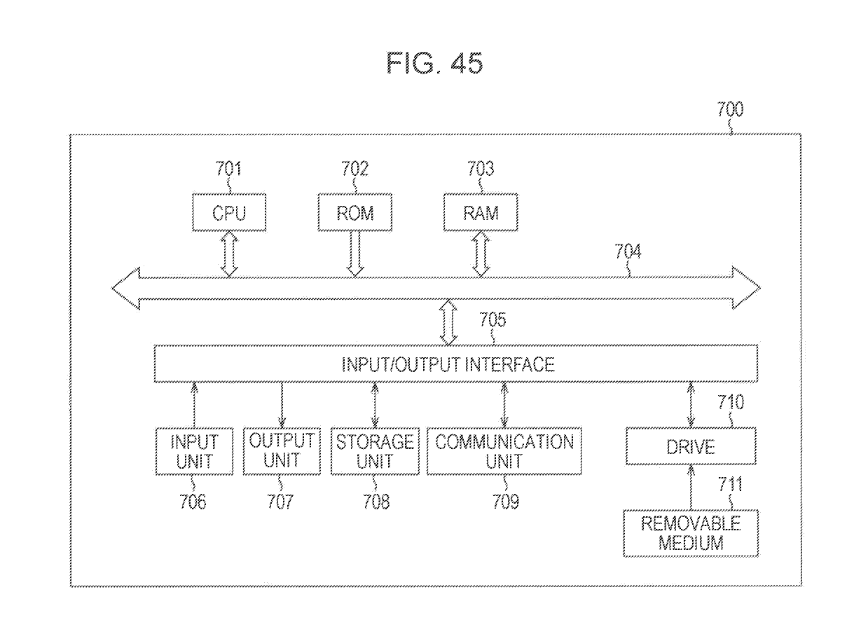

Note that the above series of processing may be executed by hardware or software. In the case of executing the above series of processing by software, a program making up the software thereof is installed in a computer housed in a dedicated hardware from a network or recording medium. Alternatively, this program is installed from a network or recording medium in, for example, a general-purpose personal computer 700 illustrated in FIG. 45 capable of executing various types of functions by installing various types of programs.

In FIG. 45, a CPU (Central Processing Unit) 701 executes various types of processing in accordance with a program stored in ROM (Read Only Memory) 702, or a program loaded from a storage unit 708 to RAM (Random Access Memory) 703. Data and the like to be used for the CPU 701 executing various types of processing are also stored in the RAM 703 as appropriate.

The CPU 701, ROM 702, and RAM 703 are mutually connected via a bus 704. An input/output interface 705 is also connected to this bus 704.

An input unit 706 made up of a keyboard, mouse, and so forth, and an output unit 707 made up of a display configured of an LCD (Liquid Crystal Display) and so forth, a speaker, and so forth are connected to the input/output interface 705. Also, a storage unit 708 made up of a hard disk and so forth, and a communication unit 709 made up of a modem, a network interface card such as a LAN card, and so forth are connected to the input/output interface 705. The communication unit 709 performs communication processing via a network including the Internet.

A drive 710 is connected to the input/output interface 705 as appropriate, on which a removable medium 711 such as a magnetic disk, optical disc, semiconductor, or the like is mounted as appropriate. Subsequently, the computer program read out from the removable medium is installed in the storage unit 708 as appropriate.

In the event of executing the above series of processing by software, a program making up the software thereof is installed from a network such as the Internet, or a recording medium made up of the removable medium 711 or the like.

Note that examples of this recording medium include not only a medium configured of the removable medium 711 made up of a magnetic disk (including floppy disk), optical disc (including CD-ROM (Compact Disc Read Only Memory), DVD (Digital Versatile Disc)), magneto-optical disc (including MD (Mini-Disk) (registered trademark)), semiconductor memory, or the like, in which the program to be distributed for distributing the program to a user separately from a device main unit illustrated in FIG. 45 is recorded, but also a medium configured of the ROM 702, a hard disk included in the storage unit 708, or the like, in which the program to be distributed to a user in a state housed beforehand in the device main unit is recorded.

It should be noted that with the Present Specification, the above series of processing include processing to be performed in the time-sequence following the described order, and also include processing executed in parallel or individually even if not performed in the time-sequence.

Also, it should be noted that embodiments of the Present Invention are not restricted to the above-described embodiments, and that various modifications may be made without departing from the spirit and scope of the Present Invention.

The present application contains subject matter related to that disclosed in Japanese Priority Patent Application JP 2009-204040 filed in the Japan Patent Office on Sep. 3, 2009, Japanese Priority Patent Applications JP 2010-027197, 2010-027198, and 2010-027199, filed in the Japan Patent Office on Feb. 10, 2010, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An image processing apparatus comprising:
dividing means configured to divide an input image into blocks having a shape determined beforehand of a predetermined number of pixels;
suitability calculating means configured to calculate, by matching a specified image specified beforehand, and the image of each of said divided blocks by standards determined beforehand, the suitability of said specified image for each of said blocks;
insertion block determining means configured to determine a block into which said specified image should be inserted based on said calculated suitability; and
specified image inserting means configured to insert said specified image by replacing the image of said determined block with said specified image.

2. The image processing apparatus according to claim 1, further comprising:
region specifying means configured to accept specification of a region into which said specified image should be inserted within said input image;
wherein said suitability calculating means calculates the suitability of said specified image by matching said specified image, and the image of a block corresponding to said region of which the specification has been accepted of the images of said divided blocks by standards determined beforehand.

3. The image processing apparatus according to claim 1, further comprising:
weighting means configured to subject the suitability calculated for each of said blocks to weighting using a weighting table to be set according to distance between said block and a block of which the position is set beforehand within said input image.

4. The image processing apparatus according to claim 1, wherein said specified image inserting means insert a plurality of said specified images into a plurality of said blocks, respectively;
and wherein said insertion block determining means set a flag representing that insertion has been done to said block into which a predetermined specified image should be inserted, and determine a block into which another specified image should be inserted out of blocks other than a block positioned within a predetermined range around of the block to which said flag has been set.

5. The image processing apparatus according to claim 1, further comprising:
photomosaic image generating means configured to classify, based on the representing value of the image of each block of said input image, each of said blocks into a plurality of classes set beforehand; classify a plurality of material images stored as an image to be pasted on said block into said plurality of classes; and determine a material image to be pasted on said block by matching each of material images classified into the same class as the class of said block, and the image of said block by standard determined beforehand.

6. The image processing apparatus according to claim 5, further comprising:
selecting means configured to select an image serving as a material image object to be pasted on said block, of a plurality of said material images.

7. The image processing apparatus according to claim 6, wherein said selecting means select an image serving as a material image object to be pasted on said block by excluding an image selected beforehand as an image which a user feels to be visually strange, from said material images.

8. The image processing apparatus according to claim 6, said selecting means comprising:
correcting means configured to correct an image including noise, a blurred image, or an image to which a frame is appended; and
presenting means configured to present an image corrected by said correcting means to said user;
wherein said selecting means select, out of said stored material images, an image serving as a material image object to be pasted on said block by excluding an image selected as an image which said user feels to be visually strange, from said material images.

9. An image processing method comprising the steps of:
dividing, with dividing means, an input image into blocks having a shape determined beforehand of a predetermined number of pixels;
calculating, with suitability calculating means, by matching a specified image specified beforehand, and the image of each of said divided blocks by standards determined beforehand, the suitability of said specified image for each of said blocks;
determining, with insertion block determining means, a block into which said specified image should be inserted based on said calculated suitability; and
inserting, with specified image inserting means, said specified image by replacing the image of said determined block with said specified image.

10. A program causing a computer to serve as an image processing apparatus comprising:
dividing means configured to divide an input image into blocks having a shape determined beforehand of a predetermined number of pixels;
suitability calculating means configured to calculate, by matching a specified image specified beforehand, and the image of each of said divided blocks by standards determined beforehand, the suitability of said specified image for each of said blocks;
insertion block determining means configured to determine a block into which said specified image should be inserted based on said calculated suitability; and
specified image inserting means configured to insert said specified image by replacing the image of said determined block with said specified image.

11. An image processing apparatus comprising:
dividing means configured to divide an input image into blocks having a shape determined beforehand of a predetermined number of pixels;
block image classifying means configured to classify each of said blocks into a plurality of classes set beforehand based on the representing value of the image of each of said divided blocks;
material image classifying means configured to classify a plurality of material images stored as an image to be pasted on said block into said plurality of classes based on the representing value of the image of each of said divided blocks;
candidate image output means configured to calculate the suitability of said material images by matching each of the material images classified into the same class as the class of said block with the image of said block by standard determined beforehand to output a plurality of candidate images serving as a candidate of a material image to be pasted on each of said blocks along with said suitability; and
candidate image selecting means configured to select a material image to be pasted on said block out of said candidate images so that the ratio of a block on which a predetermined type of image is pasted as to all of the blocks of said input image becomes a predetermined ratio.

12. The image processing apparatus according to claim 11, wherein, with all of the blocks of said input image, in the event that of said plurality of candidate images, a first candidate image of which said suitability is the highest has been pasted as said material image, when the ratio of a block on which a predetermined type of image is pasted as to all of the blocks of said input image is not matched with a ratio set beforehand, said candidate image selecting means determine an object block that is a block on which a candidate image different from said first candidate image should be pasted of all of the blocks of said input image; and replace an image to be selected as an image to be pasted on said object block with a second candidate image of which said suitability is the second highest.

13. The image processing apparatus according to claim 12, wherein said candidate image selecting means determine, after an image to be selected as an image to be pasted on said object block is replaced, with all of the blocks of said input image, whether or not the ratio of a block on which a predetermined type of image is pasted as to all of the blocks of said input image is matched with a ratio set beforehand, and in the event that determination is made that the ratio is not matched with said ratio set beforehand, determine said object block again, and replace the image of said determined object block again.

14. The image processing apparatus according to claim 12, wherein said candidate image selecting means determine said object block based on the suitability of said material image.

15. The image processing apparatus according to claim 12, wherein said candidate image selecting means eliminate, when replacing an image to be selected as an image to be pasted on said object block, the data of said material image selected before replacement.

16. The image processing apparatus according to claim 11, wherein said candidate image output means calculate, based on distance between a pixel value of a material image classified into the class of said block, and the pixel value of the corresponding pixel in the image of said block, the suitability of a material image to be pasted on said block.

17. The image processing apparatus according to claim 11, further comprising:
center value calculating means configured to calculate a center value of said plurality of classes based on the representing value of the image of each block of said input image;
wherein said block image classifying means classify, based on distance between said center value and the representing value of the image of said block, the image of said block into said plurality of classes;
and wherein said material image classifying means classify, based on the distance between said center value and the representing value of said material image, and a threshold of said distance, said material image into said plurality of classes.

18. An image processing method comprising the steps of:
dividing, with dividing means, an input image into blocks having a shape determined beforehand of a predetermined number of pixels;
classifying, with block image classifying means, each of said blocks into a plurality of classes set beforehand based on the representing value of the image of each of said divided blocks;
classifying, with material image classifying means, a plurality of material images stored as an image to be pasted on said block into said plurality of classes based on the representing value of the image of each of said divided blocks;
calculating, with candidate image output means, the suitability of said material images by matching each of the material images classified into the same class as the class of said block with the image of said block by standard determined beforehand to output a plurality of candidate images serving as a candidate of a material image to be pasted on each of said blocks along with said suitability; and
selecting out of said stored material images, with candidate image selecting means, a material image to be pasted on said block out of said candidate images so that the ratio of a block on which a predetermined type of image is pasted as to all of the blocks of said input image becomes a predetermined ratio.

19. A program causing a computer to serve as an image processing apparatus comprising:
dividing means configured to divide an input image into blocks having a shape determined beforehand of a predetermined number of pixels;
block image classifying means configured to classify each of said blocks into a plurality of classes set beforehand based on the representing value of the image of each of said divided blocks;
material image classifying means configured to classify a plurality of material images stored as an image to be pasted on said block into said plurality of classes based on the representing value of the image of each of said divided blocks;
candidate image output means configured to calculate the suitability of said material images by matching each of the material images classified into the same class as the class of said block with the image of said block by standard determined beforehand to output a plurality of candidate images serving as a candidate of a material image to be pasted on each of said blocks along with said suitability; and
candidate image selecting means configured to select a material image to be pasted on said block out of said candidate images so that the ratio of a block on which a predetermined type of image is pasted as to all of the blocks of said input image becomes a predetermined ratio.

20. An image processing apparatus comprising:
feature region extracting means configured to extract the image of a region including an object set beforehand by analyzing an input image, as a feature region;
region size detecting means configured to detect a size made up of the number of pixels of said extracted feature region;
scale determining means configured to determine, based on said detected size of said feature region, and a layout method of a block having a predetermined shape of a predetermined number of pixels, which is a layout method corresponding to the type of said extracted feature region, scale for enlarging or reducing the image of said feature region so that said block is disposed in said feature region in accordance with said layout method;
enlarging/reducing means configured to enlarge or reduce said input image based on said determined scale; and
photomosaic image generating means configured to generate a photomosaic image corresponding to said input image by dividing said enlarged or reduced input image into said blocks and pasting a material image on each of said blocks.

21. The image processing apparatus according to claim 20, further comprising:
layout method storage means configured to store a layout method corresponding to the type of said extracted feature region.

22. The image processing apparatus according to claim 20, wherein said enlarging/reducing means enlarge or reduce the size of said block based on the inverse number of the scale determined by said scale determining means without enlarging/reducing said input image.

23. The image processing apparatus according to claim 20, wherein said photomosaic image generating means classify, based on the representing value of the image of each block of said input image, each of said blocks into a plurality of classes set beforehand; classify a plurality of said material images stored as an image to be pasted on said block into said plurality of classes; and determine a material image to be pasted on said block by matching each of material images classified into the same class as the class of said block, and the image of said block by standard determined beforehand.

24. The image processing apparatus according to claim 23, said photomosaic image generating means comprising:
center value calculating means configured to calculate a center value of said plurality of classes based on the representing value of the image of each block of said enlarged or reduced input image;
wherein said photomosaic image generating means classify, based on distance between said center value and the representing value of the image of said block, the image of said block into said plurality of classes;
and wherein said photomosaic image generating means classify, based on the distance between said center value and the representing value of said material images, and a threshold of said distance, said material image into said plurality of classes.

25. The image processing apparatus according to claim 24, wherein said photomosaic image generating means change said threshold according to the number of said material images classified into each of said plurality of classes, and based on distance between said center value and the representing value of said material images, and said changed threshold, classify said material images into said plurality of classes again.

26. The image processing apparatus according to claim 23, wherein said photomosaic image generating means perform said matching by calculating, based on distance between a pixel value of a material image classified into the class of said block, and the pixel value of the corresponding pixel in the image of said block, the suitability of a material image to be pasted on said block.

27. The image processing apparatus according to claim 26, wherein said photomosaic image generating means set said material image determined to be pasted on said block to a flag representing that said material image has been used; and determine said material image to be pasted on said other blocks, which are said material image classified into the same class as the class of the block thereof, out of material images to which said flag is not set.

28. The image processing apparatus according to claim 26, wherein said photomosaic image generating means determine said material image to be pasted on a block positioned within a predetermined range around said block out of said material images other than said material image determined to be pasted on said block.

29. The image processing apparatus according to claim 26, wherein said photomosaic image generating means determine said material image to be pasted on a block adjacent to said block out of said material images of which the similarity with said material image determined to be pasted on said block is equal to or less than a threshold.

30. The image processing apparatus according to claim 26, wherein said photomosaic image generating means keep, in the event that said material image of which said suitability is equal to or greater than a threshold set beforehand does not exist, the image of this block alive without change in said input image.

31. The image processing apparatus according to claim 20, wherein said feature region extracting means extract the image of region specified by a user as a feature region.

32. The image processing apparatus according to claim 20, wherein said block to be disposed in said feature region is a block made up of a smaller number of pixels than the number of pixels to be disposed in other regions.

33. The image processing apparatus according to claim 20, further comprising:
suitability determining means configured to determine, based on a pixel of the image of a subject detected from said input image, whether or not said input image is an image suitable for generation of said photomosaic image.

34. The image processing apparatus according to claim 33, wherein said suitability determining means determine, based on difference between the value of a pixel making up the image of said detected subject, the value of a pixel of an image other than a subject adjacent to the pixels of the image of said subject, whether or not said input image is an image suitable for generation of said photomosaic image.

35. The image processing apparatus according to claim 34, wherein in the event that determination is made that said input image is not an image suitable for generation of said photomosaic image, said suitability determining means select a plurality of pixel value candidates used for said input image becoming an image suitable for generation of said photomosaic image, which are pixel values of an image other than a subject corresponding to the pixel values of the image of said detected subject; determine, based on the representing value of a plurality of said material images stored beforehand, the pixel values of the image other than said subject out of said plurality of candidates; and convert the pixel values of the image other than said subject using said determined pixel values.

36. The image processing apparatus according to claim 33, wherein said suitability determining means determine, based on the number of pixels making up the image of said detected subject, and the number of pixels making up the whole of said input image, whether or not said input image is an image suitable for generation of said photomosaic image.

37. An image processing method comprising the steps of:
extracting, with feature region extracting means, the image of a region including an object set beforehand by analyzing an input image, as a feature region;
detecting, with region size detecting means, a size made up of the number of pixels of said extracted feature region;
determining, with scale determining means, based on said detected size of said feature region, and a layout method of a block having a predetermined shape of a predetermined number of pixels, which is a layout method corresponding to the type of said extracted feature region, scale for enlarging or reducing the image of said feature region so that said block is disposed in said feature region in accordance with said layout method;
enlarging or reducing, with enlarging/reducing means, said input image based on said determined scale; and
generating, with photomosaic image generating means, a photomosaic image corresponding to said input image by dividing said enlarged or reduced input image into said blocks and pasting a material image on each of said blocks.

38. A program causing a computer to serve as an image processing apparatus comprising:
feature region extracting means configured to extract the image of a region including an object set beforehand by analyzing an input image, as a feature region;
region size detecting means configured to detect a size made up of the number of pixels of said extracted feature region;
scale determining means configured to determine, based on said detected size of said feature region, and a layout method of a block having a predetermined shape of a predetermined number of pixels, which is a layout method corresponding to the type of said extracted feature region, scale for enlarging or reducing the image of said feature region so that said block is disposed in said feature region in accordance with said layout method;
enlarging/reducing means configured to enlarge or reduce said input image based on said determined scale; and
photomosaic image generating means configured to generate a photomosaic image corresponding to said input image by dividing said enlarged or reduced input image into said blocks and pasting a material image on each of said blocks.

39. An image processing apparatus comprising:
a dividing unit configured to divide an input image into blocks having a shape determined beforehand of a predetermined number of pixels;
a suitability calculating unit configured to calculate, by matching a specified image specified beforehand, and the image of each of said divided blocks by standards determined beforehand, the suitability of said specified image for each of said blocks;
an insertion block determining unit configured to determine a block into which said specified image should be inserted based on said calculated suitability; and
a specified image inserting unit configured to insert said specified image by replacing the image of said determined block with said specified image.

40. A program causing a computer to serve as an image processing apparatus comprising:
a dividing unit configured to divide an input image into blocks having a shape determined beforehand of a predetermined number of pixels;
a suitability calculating unit configured to calculate, by matching a specified image specified beforehand, and the image of each of said divided blocks by standards determined beforehand, the suitability of said specified image for each of said blocks;
an insertion block determining unit configured to determine a block into which said specified image should be inserted based on said calculated suitability; and
a specified image inserting unit configured to insert said specified image by replacing the image of said determined block with said specified image.

41. An image processing apparatus comprising:
a dividing unit configured to divide an input image into blocks having a shape determined beforehand of a predetermined number of pixels;
a block image classifying unit configured to classify each of said blocks into a plurality of classes set beforehand based on the representing value of the image of each of said divided blocks;
a material image classifying unit configured to classify a plurality of material images stored as an image to be pasted on said block into said plurality of classes based on the representing value of the image of each of said divided blocks;
a candidate image output unit configured to calculate the suitability of said material images by matching each of the material images classified into the same class as the class of said block with the image of said block by standard determined beforehand to output a plurality of candidate images serving as a candidate of a material image to be pasted on each of said blocks along with said suitability; and
a candidate image selecting unit configured to select a material image to be pasted on said block out of said candidate images so that the ratio of a block on which a predetermined type of image is pasted as to all of the blocks of said input image becomes a predetermined ratio.

42. A program causing a computer to serve as an image processing apparatus comprising:
a dividing unit configured to divide an input image into blocks having a shape determined beforehand of a predetermined number of pixels;
a block image classifying unit configured to classify each of said blocks into a plurality of classes set beforehand based on the representing value of the image of each of said divided blocks;
a material image classifying unit configured to classify a plurality of material images stored as an image to be pasted on said block into said plurality of classes based on the representing value of the image of each of said divided blocks;
a candidate image output unit configured to calculate the suitability of said material images by matching each of the material images classified into the same class as the class of said block with the image of said block by standard determined beforehand to output a plurality of candidate images serving as a candidate of a material image to be pasted on each of said blocks along with said suitability; and
a candidate image selecting unit configured to select a material image to be pasted on said block out of said candidate images so that the ratio of a block on which a predetermined type of image is pasted as to all of the blocks of said input image becomes a predetermined ratio.

43. An image processing apparatus comprising:
a feature region extracting unit configured to extract the image of a region including an object set beforehand by analyzing an input image, as a feature region;
a region size detecting unit configured to detect a size made up of the number of pixels of said extracted feature region;
a scale determining unit configured to determine, based on said detected size of said feature region, and a layout method of a block having a predetermined shape of a predetermined number of pixels, which is a layout method corresponding to the type of said extracted feature region, scale for enlarging or reducing the image of said feature region so that said block is disposed in said feature region in accordance with said layout method;
an enlarging/reducing unit configured to enlarge or reduce said input image based on said determined scale; and
a photomosaic image generating unit configured to generate a photomosaic image corresponding to said input image by dividing said enlarged or reduced input image into said blocks and pasting a material image on each of said blocks.

44. A program causing a computer to serve as an image processing apparatus comprising:
a feature region extracting unit configured to extract the image of a region including an object set beforehand by analyzing an input image, as a feature region;
a region size detecting unit configured to detect a size made up of the number of pixels of said extracted feature region;
a scale determining unit configured to determine, based on said detected size of said feature region, and a layout method of a block having a predetermined shape of a predetermined number of pixels, which is a layout method corresponding to the type of said extracted feature region, scale for enlarging or reducing the image of said feature region so that said block is disposed in said feature region in accordance with said layout method;
an enlarging/reducing unit configured to enlarge or reduce said input image based on said determined scale; and
a photomosaic image generating unit configured to generate a photomosaic image corresponding to said input image by dividing said enlarged or reduced input image into said blocks and pasting a material image on each of said blocks.
